(19) United States
(12) Patent Application Publication
(10) Pub. No.: US 2026/0192728 A1
(43) Pub. Date: Jul. 9, 2026

(54) TOW TRUCK WHEEL LIFT ASSEMBLIES

(71) Applicant: Iman Nonahal, Tarzana, CA (US)

(72) Inventor: Iman Nonahal, Tarzana, CA (US)

(21) Appl. No.: 19/011,246

(22) Filed: Jan. 6, 2025

Related U.S. Application Data
(63) Continuation-in-part of application No. 17/561,296, filed on Dec. 23, 2021, now Pat. No. 12,187,175.
(60) Provisional application No. 63/130,350, filed on Dec. 23, 2020.
(60) Provisional application No. 63/172,621, filed on Apr. 8, 2021.

(51) Int. Cl. B60P 3/12

(52) U.S. Cl. CPC B60P 3/122

(57) ABSTRACT

A hydraulic wheel lift assembly of a tow truck includes first, second, third, and fourth wheel retainers. Each wheel retainer includes a frame and several rollers connected to the corresponding frame. The first and second wheel retainers hold a first wheel of a vehicle off the ground during a towing operation, and the third and fourth wheel retainers hold a second wheel of the vehicle off the ground during the towing operation. The rollers of the first and second wheel retainers engage the opposite sides of the first wheel of the vehicle, and the rollers of the third and fourth wheel retainers engage the opposite sides of the second wheel of the vehicle. The rollers of the first, second, third, and fourth wheel retainers are configured to allow the first and second wheels of the vehicle to rotate during the towing operation.

### CLAIM OF BENEFIT TO PRIOR APPLICATIONS

This application is a continuation-in-part of U.S. patent application Ser. No. 17/561,296, filed on Dec. 23, 2021. U.S. patent application Ser. No. 17/561,296 claims the benefit of U.S. Provisional Patent Application Ser. No. 63/130,350, filed on Dec. 23, 2020, and U.S. Provisional Patent Application Ser. No. 63/172,621, filed on Apr. 8, 2021. The contents of U.S. patent application Ser. No. 17/561,296, U.S. Provisional Patent Application 63/130,350, and U.S. Provisional Patent Application 63/172,621 are hereby incorporated by reference.

### BACKGROUND

Tow trucks, also known as recovery vehicles or wreckers, are specialized vehicles designed to move other motor vehicles, such as those involved in accidents, impounded, or disabled. Common types of tow trucks include wheel-lift, flatbed, boom, self-loader, hook and chain, and integrated models. A wheel-lift tow truck uses a metal yoke hooked under the drive wheels of a vehicle, which are then lifted off the ground by a hydraulic system. Hook and chain tow trucks, now rarely used, operate similar to the wheel-lift tow trucks but utilize a hook secured to the vehicle's axle or bumper, along with chains that wrap around the vehicle's frame to lift the drive wheels of the vehicle. Flatbed tow trucks have a bed that may be inclined to allow a vehicle to be driven or pulled onto the bed. Boom tow trucks are equipped with a boom and winch to recover vehicles from ditches or other hard-to-reach locations. Integrated tow trucks include both a boom and a wheel lift system.

Many of the above-mentioned tow trucks use hydraulic lifts and booms, which operate using liquid fluid. The hydraulic fluid is pumped into hydraulic motors and cylinders and becomes pressurized under resistance within a closed system. The fluid used in a hydraulic fluid is not compressible and may transmit any pressure applied to the fluid in the closed system in all directions.

### BRIEF DESCRIPTION OF THE DRAWINGS

The various embodiments of the present tow truck wheel lift assemblies now will be discussed in detail with an emphasis on highlighting the advantageous features. These embodiments depict the novel and non-obvious tow truck wheel lift assemblies shown in the accompanying drawings, which are for illustrative purposes only. These drawings include the following figures, in which like numerals indicate like parts:

FIGS. 1A-1B are side perspective views of a tow truck with a first hydraulic wheel lift assembly for lifting a first pair of wheels of a vehicle and a second hydraulic wheel lift assembly for attaching the other pair of wheels of the vehicle to towing wheels, according to various aspects of the present disclosure;

FIG. 1C is a side perspective view of the tow truck of FIGS. 1A-1B where the two hydraulic wheel lift assemblies are used to tow a vehicle, according to various aspects of the present disclosure;

FIG. 1D is a perspective view of a portion of the tow truck of FIGS. 1A-1C where a pair of straps are used to prevent movements of the two wheels of the vehicle being towed that are closer to the tow truck, according to various aspects of the present disclosure;

FIG. 1E is a perspective view of a portion of the tow truck of FIGS. 1A-1C illustrating another example of securing the vehicle being towed using a pair of straps, according to various aspects of the present disclosure;

FIGS. 2A-2B are side perspective views of a tow truck similar to the tow truck of FIGS. 1A-1B, where the wheel retainers of the second hydraulic wheel lift assembly do not include rollers, according to various aspects of the present disclosure;

FIG. 2C is a side perspective view of a tow truck similar to the tow truck of FIGS. 1A-1B, with an alternative design for the first hydraulic wheel lift assembly, according to various aspects of the present disclosure;

FIG. 3A is a top perspective view of the wheel retainer structure of the first hydraulic wheel lift of a tow truck, according to various aspects of the present disclosure;

FIG. 3B illustrates a wheel lift apparatus in the towing position, according to prior art;

FIGS. 3C and 3D are top perspective views of the wheel retainer structure of the first hydraulic wheel lift of a tow truck where a rotating bar is used to prevent movements of the wheels of the vehicle being towed, according to various aspects of the present disclosure;

FIG. 3E is a top perspective view of the wheel retainer structure of the first hydraulic wheel lift of a tow truck where the rollers are positioned inside the cross bar of the wheel retainer structure, according to various aspects of the present disclosure;

FIG. 4A is a front perspective view of a wheel retainer that includes a set of rollers, according to various aspects of the present disclosure;

FIG. 4B is a front perspective view of a wheel retainer that includes more than one roller per row, according to various aspects of the present disclosure;

FIG. 5 is a front perspective view of a wheel retainer's roller, according to various aspects of the present disclosure;

FIG. 6A is a front perspective view of a pair of wheel retainers, each with a frame and a curved plate, fitted around the wheel of a vehicle being towed, according to various aspects of the present disclosure;

FIG. 6B is a front perspective view of a pair of wheel retainers, each with a frame and no plate, fitted around the wheel of a vehicle being towed, according to various aspects of the present disclosure;

FIG. 7 is a top perspective view of the wheel retainer structure of the second hydraulic wheel lift assembly that may be used for attaching towing wheels, according to various aspects of the present disclosure;

FIG. 8 is functional diagram illustrating an example use of two tow dollies for lifting a pair of wheels of a vehicle, according to prior art;

FIG. 9 is functional diagram illustrating the operation of the tow dolly of FIG. 8, according to prior art;

FIG. 10 is a top perspective view of the wheel retainer structure of the second hydraulic wheel lift assembly with two towing wheels on each side of the wheel retainer structure, according to various aspects of the present disclosure;

FIG. 11 is a top perspective view of the wheel retainer structure of the second hydraulic wheel lift assembly with one towing wheel on each side of the wheel retainer structure and no spindles, according to various aspects of the present disclosure;

FIGS. 12A-12B are side perspective views of an alternative embodiment of a tow truck with a first hydraulic wheel lift assembly for lifting a first pair of wheels of a vehicle and a second hydraulic wheel lift assembly for attaching the second pair of wheels of the vehicle to towing wheels, according to various aspects of the present disclosure;

FIG. 13 illustrates a front perspective view of a tow truck wheel retainer, according to prior art;

FIG. 14 illustrates a top perspective view of a tow truck wheel retainer structure, according to various aspects of the present disclosure;

FIG. 15 illustrates a top perspective view of a tow truck wheel retainer with a cross bar and two L-shaped bars, according to prior art;

FIGS. 16A-16B are side perspective views of a tow truck with two hydraulic wheel lift assemblies where each hydraulic wheel lift assembly is attached to a wheel retainer with a cross bar and two L-shaped bars, according to various aspects of the present disclosure;

FIG. 17 illustrates a top perspective view of a tow truck wheel retainer with a cross bar, two L-shaped bars, and four sets of rollers, according to prior art;

FIGS. 18A-18B are side perspective views of a tow truck with one hydraulic wheel lift assembly attached to a wheel retainer with a cross bar, two L-shaped bars, and four sets of rollers, and another hydraulic wheel lift assembly attached to a wheel retainer with a cross bar and two L-shaped bars, according to various aspects of the present disclosure;

FIG. 19 is a side perspective view of a tow truck with a hydraulic wheel lift assembly with four sets of rollers for retaining the wheels of a vehicle, which are closer to the tow truck, according to various aspects of the present disclosure FIG. 20 is a side perspective view of a tow truck with a hydraulic wheel lift assembly attached to a wheel retainer with a cross bar, two L-shaped bars, and four sets of rollers for retaining the wheels of a vehicle, which are closer to the tow truck, according to various aspects of the present disclosure;

FIG. 21A is a side perspective view of a tow truck with two hydraulic wheel lift assemblies that may extend, for at least a portion of their lengths, through a common axis, according to various aspects of the present disclosure;

FIG. 21B is a side perspective view of the tow truck of FIG. 21A after the first hydraulic wheel lift assembly is lifted up, according to various aspects of the present disclosure;

FIG. 21C is a side perspective view of the tow truck of FIG. 21A after both hydraulic wheel lift assemblies are lifted up, according to various aspects of the present disclosure; and

FIG. 22 is a side perspective view of a tow truck with a boom to lift the wheels of a vehicle that are closer to the tow truck and a hydraulic wheel lift assembly for placing towing wheels under the wheels of the vehicle that are father from the tow truck, according to various aspects of the present disclosure.

### DETAILED DESCRIPTION

One aspect of the present embodiments includes the realization that the existing wheel-lift tow trucks use only one hydraulic wheel lift to lift one pair of the wheels of a vehicle that is being towed. If the vehicle is a two-wheel drive vehicle and the driving wheels of the vehicle are lifted up, the other two wheels may stay on the ground during towing. However, the other two wheels may have to be lifted if the vehicle is all-wheel drive or the wheels are damaged (e.g., in an accident). The other two wheels are typically lifted off the ground (e.g., by a jack) and are placed on towing wheels. A more recent way of lifting the other two wheels of a vehicle is using a so-called tow dolly (or self-loading dolly) to lift the wheels.

Using a jack for placing the towing wheels under the vehicle is time consuming and wastes the tow truck driver's time. Using tow dollies require placing two axels underneath the vehicle on each side of the pair of wheels that are farther from the tow truck and are going to be lifted up by the tow dollies. The axels then have to be extended to span the width of the vehicle. One tow dolly has to be connected to each side of axels. The tow dollies have to be secured by passing ratchet straps behind the vehicle's wheels and attaching the hook ends of the straps to the tow dollies.

In addition to being time consuming to setup, the jacks and the tow dollies are heavy. For example, each tow dolly used for lifting one wheel of a vehicle may weight more than 50 pounds. Each time a vehicle is being towed, the tow truck driver has to pick up two tow dollies and two axels. The tow dollies have to be placed on each side of the car and have to be connected to each other by the two axels that are extended below the frame of the car. After the towing is done, the tow dollies and the axels have to be picked up and placed back on the tow truck. Repeatedly lifting the jack or the tow dollies from the tow truck bed and placing them back may cause injuries such as, back injuries, joint injuries, etc., to the tow truck drivers.

The present embodiments, as described in detail below, solve the above-mentioned problems by providing a second hydraulic wheel lift assembly for the wheel-lift tow trucks. The first hydraulic wheel lift assembly may be used as a traditional hydraulic wheel lift assembly to lift the two wheels of a vehicle that are closer to the tow truck. The second hydraulic wheel lift may then extend below the first hydraulic wheel lift assembly to reach the two wheels of the vehicle that are farther from the tow truck. The first and second hydraulic wheel lift assemblies may include wheel retainers for holding the corresponding wheels of the vehicle that are being lifted by the first and second hydraulic wheel lifts.

The wheel retainers of the second hydraulic wheel lift assembly may include shafts that may be attached to the towing wheels for holding the wheels of the vehicle that are farther from the tow truck above the ground. The only relatively heavy items that are lifted by the tow truck driver are the small towing wheels attached to the corresponding portions of the wheel retainers. The use of the second hydraulic wheel lift assembly, therefore, provides safety for the tow truck drivers and reduces the time to prepare a vehicle for towing.

Another aspect of the present embodiments includes the realization that the existing tow trucks use wheel retainers that include a wheel grid, which is attached to the tow truck's hydraulic wheel lift assembly, and an attachable L-shaped bar to hold the two sides of a vehicle's wheel for lifting up the wheel. The wheel grid is a substantially rectangular object with a slanted surface attached to one of its sides. To prepare a vehicle's wheels for lifting, the hydraulic wheel lift assembly is lowered such that the slanted surface touches the side of wheel that is closer to the tow truck. One side of the L-shaped bar is then placed on the opposite side of the wheel. The other side of the L-shaped bar is attached to the hydraulic wheel lift assembly and is tightened such that the wheel may not be able to turn. The same process is repeated with another wheel of the vehicle and both wheels are then lifted by the hydraulic wheel lift assembly.

For an all-wheel drive vehicle, the other two wheels of the vehicle have to also be lifted and placed on towing wheels to prevent damage to the drivetrain of the vehicle during towing. However, in some situations, the other two wheels may have to be temporarily taken off the towing wheels and placed on the ground during periods of towing. For example, when the vehicle is in a subterranean parking with a steep ramp, the portion of the vehicle that is over the towing wheels may not clear the ramp.

In these situations, when the vehicle is being towed by the existing tow trucks, the two wheels that are placed over the towing wheels have to be put back on the ground and the vehicle has to be pulled up the ramp while the other two wheels are lifted by the tow truck. Since two of the wheels are on the ground and the other two wheels that are lifted cannot rotate, the drivetrain of the vehicle may be damaged. Using a flatbed tow truck may also not be practical as the vehicle placed on top of the flatbed tow truck may not clear the ramp.

The present embodiments, as described in detail below, solve the above-mentioned problems by providing wheel retainers that include one or more rollers. The vehicle's wheels that are to be lifted may be placed between two wheel retainers with rollers. When there is a need to lift only two wheels of an all-wheel drive vehicle from the ground and place the other two wheels on the ground and allow them to rotate, the two wheels that are lifted may also rotate over the rollers. The rollers, therefore, prevent damage to the drivetrain of the all-wheel drive vehicle when the vehicle has to be towed over a distance with two of the wheels on the ground.

The remaining detailed description describes the present embodiments with reference to the drawings. In the drawings, reference numbers label elements of the present embodiments. These reference numbers are reproduced below in connection with the discussion of the corresponding drawing features.

Some embodiments provide a tow truck with two hydraulic wheel lift assemblies. The first hydraulic wheel lift assembly may be used as a traditional hydraulic wheel lift to lift the two wheels of a vehicle that are closer to the tow truck. The second hydraulic wheel lift assembly may then extend below the first hydraulic wheel lift to reach the other two wheels of the vehicle that are farther from the tow truck.

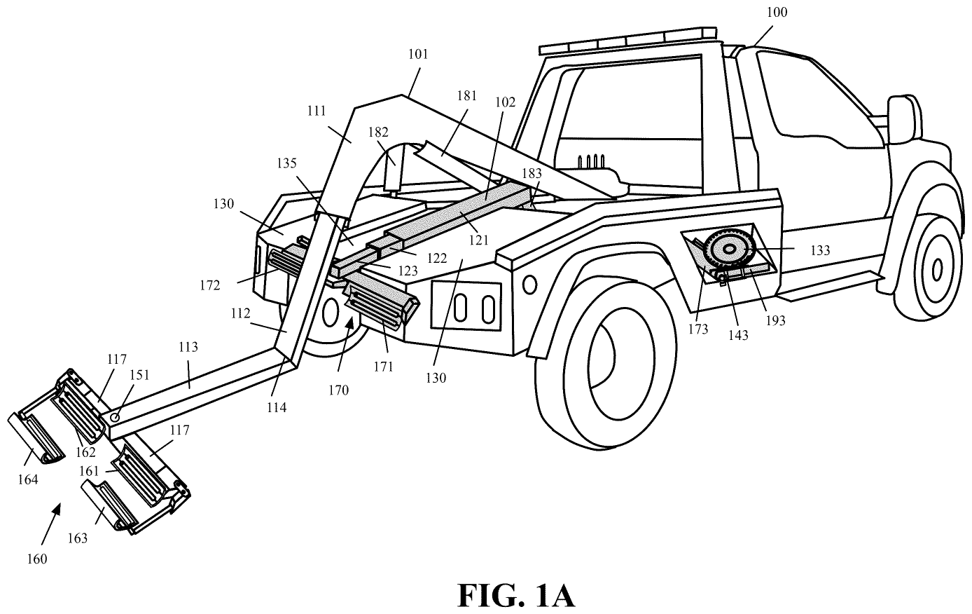

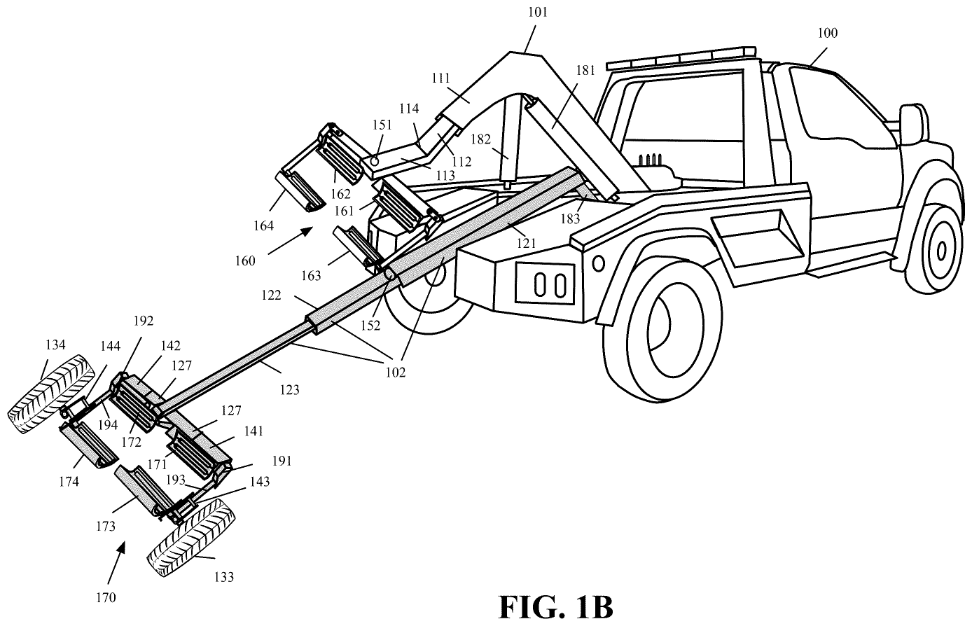

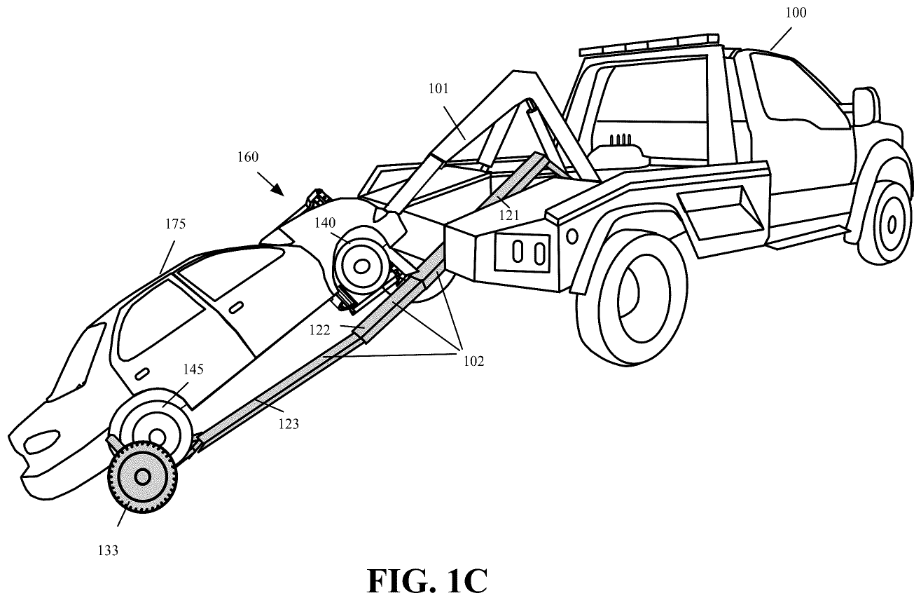

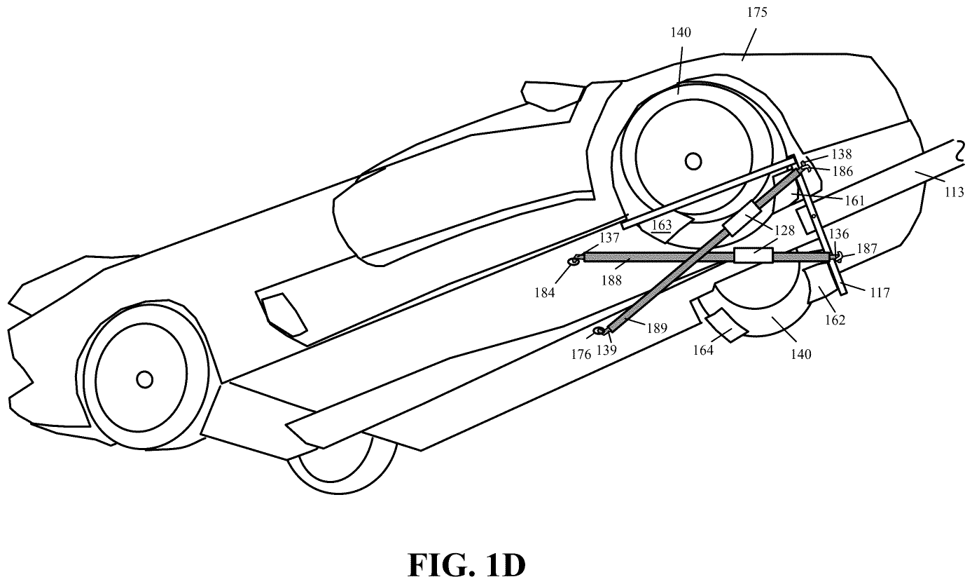

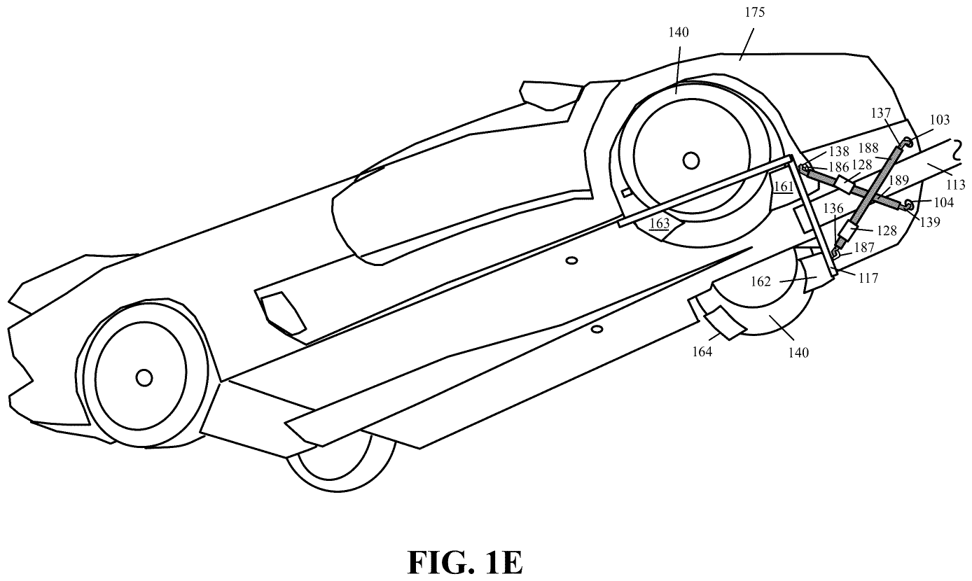

FIGS. 1A-1B are side perspective views of a tow truck with a first hydraulic wheel lift assembly for lifting a first pair of wheels of a vehicle and a second hydraulic wheel lift assembly for attaching the other pair of wheels of the vehicle to towing wheels, according to various aspects of the present disclosure. The tow truck 100, also referred to as a wrecker or a recovery vehicle, may be used to tow vehicles that are involved in accidents, impounded, disabled, etc.

With reference to FIGS. 1A-1B, the tow truck 100 may include a wheel lift apparatus that include two hydraulic wheel lift assemblies (also referred to herein as hydraulic wheel lifts) 101 and 102. The hydraulic wheel lift assembly refers to a wheel lift assembly that includes one or more hydraulically operated components that move through the force of liquid pressure.

The hydraulic wheel lift assembly 101 may be used to lift the two wheels of a vehicle that are closer to the tow truck 100. The hydraulic wheel lift assembly 102 may extend and retract below the first hydraulic wheel lift assembly 101. The hydraulic wheel lift assembly 102 may be used to attach to towing wheels 133 and 134 (FIG. 1B) to lift the two wheels of the vehicle that are farther from the tow truck 100. The two hydraulic wheel lift assemblies 101 and 102 may be separate from each other. The two hydraulic wheel lift assemblies 101 and 102 may move independent of each other.

In this specification, the term wheel refers to a circular object made of a material, such as, metal or carbon fiber that includes a rim and a disk. The tire is a ring-shaped rubber object that is fastened around the rim of the wheel. The disk is used to connect the wheel to the vehicle's axel hub. For simplicity, the term wheel is used when describing the towing operation. It should be noted that, unless the tire of the vehicle being towed is removed or is destroyed in an accident, the rim of a wheel is typically covered by a tire.

FIG. 1C is a side perspective view of the tow truck 100 of FIGS. 1A-1B where the two hydraulic wheel lift assemblies are used to tow a vehicle, according to various aspects of the present disclosure. As shown in FIG. 1C, the first hydraulic wheel lift assembly 101 is used to lift the first pair of wheels 140 of the vehicle 175 that are closer to the truck 100 (in this example the front wheels). The second hydraulic wheel lift assembly 102 is used to lift the second pair of wheels 145 of the vehicle 175 that are farther from the truck 100 (in this example the back wheels). In the side perspective view of FIG. 1C, only one of each wheels 133, 140, and 145 is shown.

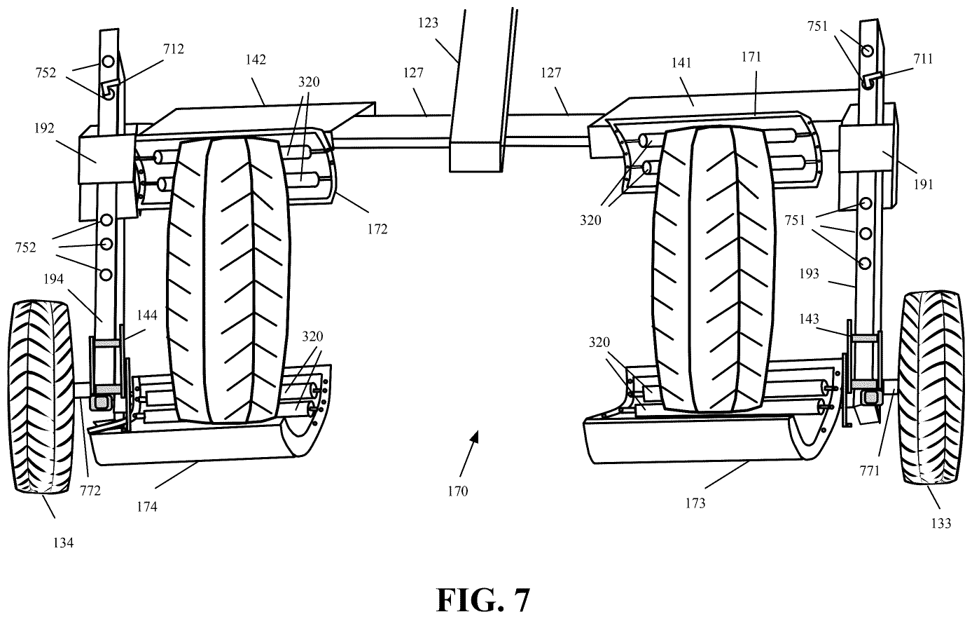

In order to keep the second pair of wheels 145 of the vehicle 175 off the ground, some embodiments may attach one or two towing wheels to each side of the hydraulic wheel lift assembly 102. In the example of FIG. 1C, one towing wheel is connected to each side of the hydraulic wheel lift assembly 102. Further details of the towing wheels are described below with reference to FIGS. 7 and 10-11.

Referring back to FIGS. 1A-1B, the bed 130 on the upper back of the tow truck 100, in some embodiments, may be slanted such that the edge of the bed 130 that is closer to the back of the truck 100 is lower than the edge that is farther from the back of the truck 100. The bed 130 of the truck 100 may include a recess (or cavity) 135. The hydraulic wheel lift assembly 102, in some embodiments, such as the embodiment depicted in FIGS. 1A-1B, may at least be partially located inside the recess 135.

FIG. 1A shows the hydraulic wheel lift assembly 101 being extended before the first pair 140 of the vehicle 175 (FIG. 1C) is lifted from the ground. The vehicle 175 (FIG. 1C) being lifted is not shown in FIGS. 1A-1B to prevent the image of the vehicle 175 from blocking the details of the wheel lift assemblies 101 and 102. The hydraulic wheel lift assembly 102 in FIG. 1A is shown to be stowed inside the recess 135. FIG. 1B shows the hydraulic wheel lift 101 in a position where the first pair of the wheels 140 of the vehicle 175 (FIG. 1C) are lifted from the ground. The hydraulic wheel lift assembly 102 in FIG. 1B is shown being extended to reach the second pairs of wheels 145 of the vehicle 175 (FIG. 1C).

With continued reference to FIGS. 1A-1B, the hydraulic wheel lift assembly 101 may include several beams 111-113. The two hydraulic cylinders 181-182 may be configured to move the hydraulic wheel lift assembly 101, including the beams 111-113, up, down, forward, backward, and sideways. Other embodiments may include fewer or more than two hydraulic cylinders for moving the hydraulic wheel lift assembly 101. A hydraulic cylinder may get its power from pressurized hydraulic fluid, which is typically oil. The hydraulic cylinder may include a barrel, in which a piston may move back and forth.

The beams 111-113, in some embodiments, may have portions with substantially rectangular cross sections. At least some of the beams, such as the beam 111 may be hollow to facilitate a telescopic movement. In the example of FIGS. 1A-1B, the beams 111 and 112 are telescopic, with the beam 112 having a smaller cross section than the beam 111 to allow the beam 112 to telescopically move in and out of the hollow interior of the beam 111.

The hydraulic wheel lift assembly 101, in some embodiments, may include a hinge (or movable joint) 114 between the beams 112 and 113 to allow the beams 112 and 113 to move at an angle and tilt against each other. In the example of FIGS. 1A-1B, the hydraulic wheel lift assembly 101 is shown to include three beams 111-113, where the beam 112 may telescopically move in and out of the beam 111 and the beam 113 may rotate around the hinge 114 against the beam 112. In other embodiments, the hydraulic wheel lift assembly 101 may include fewer or more than three beams, may include more than two telescopic arms, may include more than two arms with hinges between them, may include no telescopic arms, and/or may include no hinges between the arms.

The hydraulic cylinder 183 may be configured to move the hydraulic arm assembly 102 up, down, forward, and backward. Other embodiments may include no external hydraulic cylinders or may include more than one hydraulic cylinders for moving the hydraulic wheel lift assembly 102. The hydraulic wheel lift assembly 102 may include several beams 121-123. The beams 121-122, in some embodiments, may have substantially rectangular cross sections. At least some of the beams, such as the beams 121-122 may be hollow to facilitate telescopic movements.

In the example of FIGS. 1A-1B, the hydraulic wheel lift assembly 102 is shown to include three telescoping beams 121-123. In other embodiments, the hydraulic wheel lift assembly 102 may include fewer or more than three telescopic beams. In some embodiments, the hydraulic wheel lift assembly 102 may include beams with hinges between them (e.g., similar to the beams 112-113 and the hinge 114 of the first hydraulic wheel lift assembly 101) to facilitate rotating movement of the beams against each other.

The beam 113 of the first hydraulic wheel lift assembly 101 may be attached to the cross bar 117 by the pivot 151. The pivot 151 may allow the cross bar 117 to rotate against the beam 113 when then tow truck 100 turns during towing operations. The hydraulic wheel lift 102 assembly, in some embodiments, may also include a pivot 152 (FIG. 1B), which may be configured to be in a substantially above (e.g., in the same vertical plane as) the pivot 150, when both wheel lift assemblies 101 and 102 are extended during towing.

In some embodiments, a pair of straps may be used to prevent the first pair of wheels 140 of the vehicle 175 that are closer to the truck 100 from moving side to side while the pair of wheels 140 are lifted by the first hydraulic wheel lift assembly 101. FIG. 1D is a perspective view of a portion of the tow truck 100 of FIGS. 1A-1C where a pair of straps are used to prevent movements of the two wheels of the vehicle being towed that are closer to the tow truck, according to various aspects of the present disclosure.

FIG. 1D shows a portion of the beam 113 of the first hydraulic wheel lift assembly 101. In the embodiment of FIG. 1D, the cross bar 117 of the first hydraulic wheel lift assembly 101 may include the hooks 186 and 187. After the first pair of wheels 140 of the vehicle 175 that are closer to the truck 100 are lifted from the ground by the he first hydraulic wheel lift assembly 101, two straps 188 and 189 may be used to prevent the wheels 140 from moving side to side. For example, the strap 188 may include the hooks 136 and 137 on each side, and the strap 189 may include the hooks 138 and 139 on each side. The hooks 137 and 139 may be, for example, J-hooks or T-hooks. The hook 136 of the strap 188 may be secured around the hook 187 of the cross bar 117, and the hook 137 of the strap 188 may be secured to a part 184 on the underside of the vehicle 175. The part 184 may be, for example, a hole, the K frame, the frame, etc. The hook 138 of the strap 189 may be secured around the hook 186 of the cross bar 117, and the hook 139 of the strap 189 may be secured to a part 176 on the underside of the vehicle 175. The part 176 may be, for example, a hole, the K frame, the frame, etc. The straps 188 and 189, in some embodiments, may be tighten up by buckles or ratchets 128.

In the past, hooks similar to the hooks 186 and 187 were used to attach a chain around the wheels of the vehicle that was being towed. The chain was then connected to the lift assembly to lift the vehicles'wheels. In contrast, the present embodiments attach straps to the hooks 186 and 187 after the wheels are lifted from the ground to prevent the movement of the wheels 140 of the vehicle 175 that is being towed.

FIG. 1E is a perspective view of a portion of the tow truck 100 of FIGS. 1A-1C illustrating another example of securing the vehicle being towed using a pair of straps, according to various aspects of the present disclosure. With reference to FIG. 1E, the straps 188 and 189 are similar to the straps 188 and 189 shown in FIG. 1D. In the example of FIG. 1E, the hook 137 of the strap 188 and the hook 139 of the strap 189 may be secured to parts 103 and 104 on the underside of the vehicle 175, respectively. The parts 103 and 104 may be closer to the tow truck than the hooks 186 and 187. The parts 103 and 104 may be, for example, holes, the K frame, the frame, the radiator, etc.

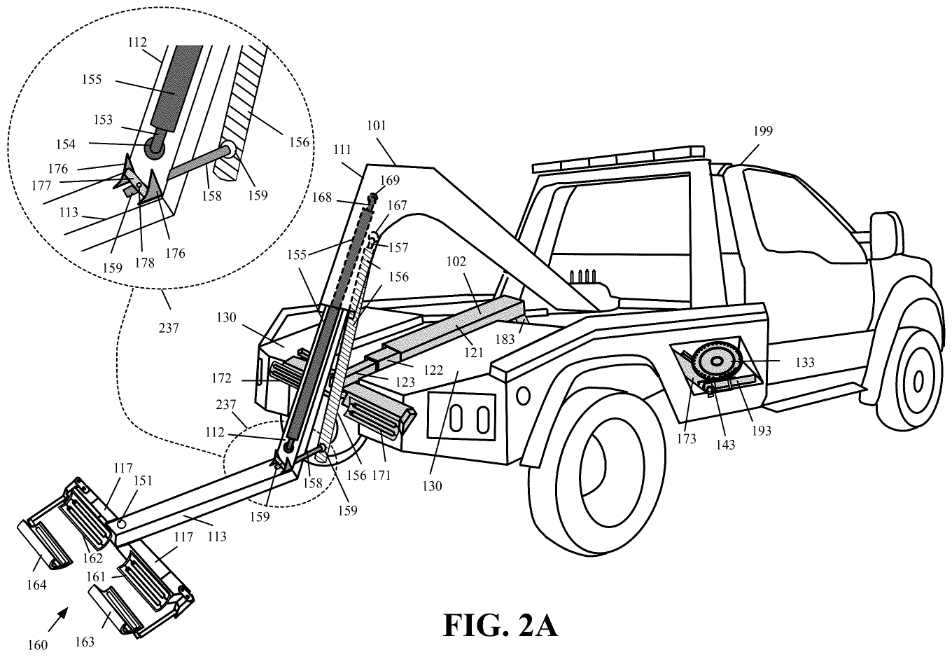

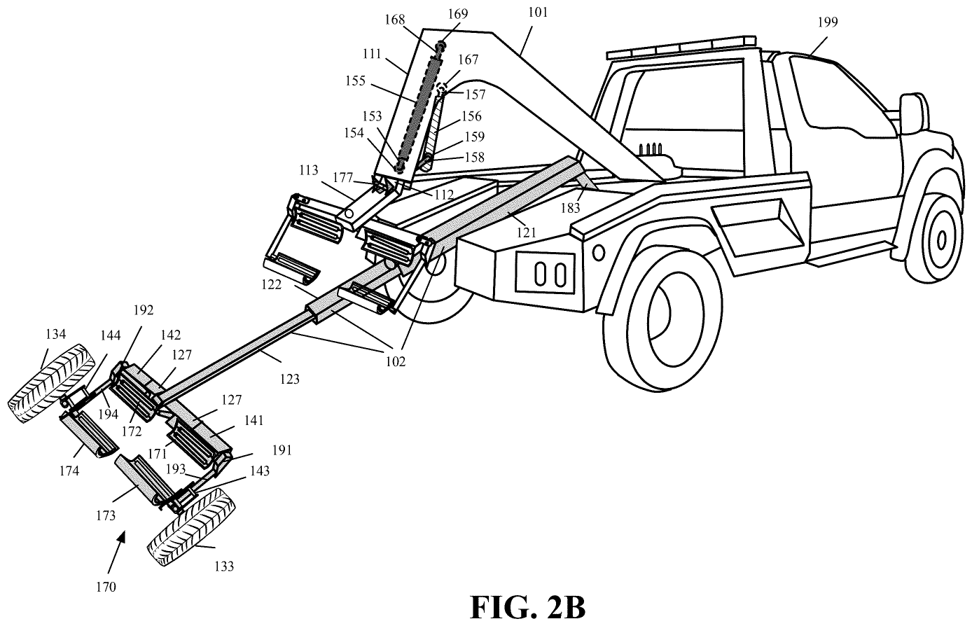

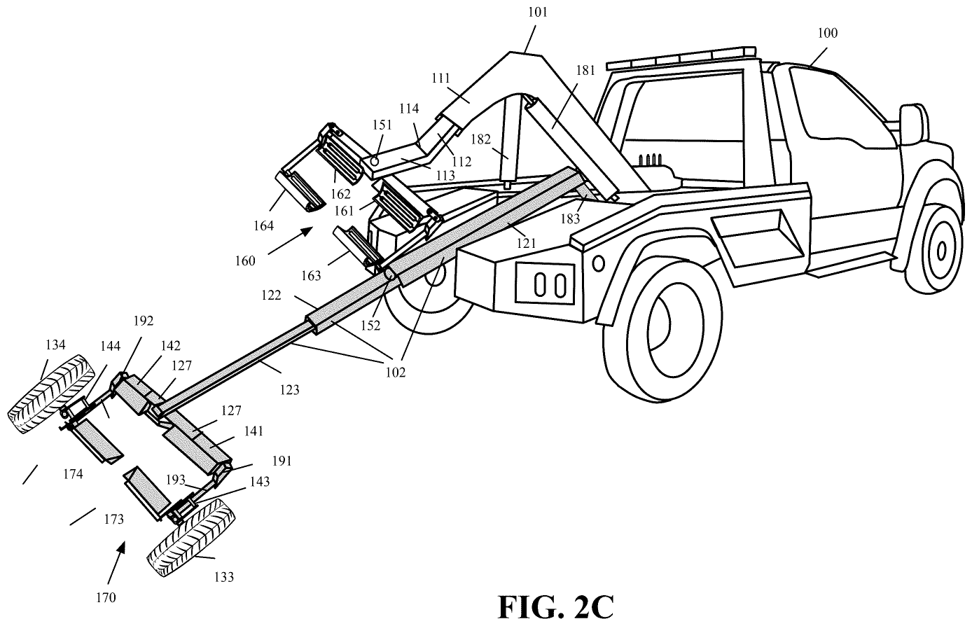

FIGS. 2A-2B are side perspective views of a tow truck similar to the tow truck of FIGS. 1A-1B, with an alternative design for the first hydraulic wheel lift, according to various aspects of the present disclosure. With reference to FIGS. 2A-2B, the tow truck 199 may be similar to the tow truck 100 of FIGS. 1A-1B, except for the hydraulic wheel lift assembly 101. In the example of FIGS. 1A-1B, the two hydraulic cylinders 181-182 may be configured to move the hydraulic wheel lift 101 assembly, including the beam 111 up, down, forward, backward, and sideways.

In contrast, the embodiment of FIGS. 2A-2B does not include the hydraulic cylinders 181-182, In these embodiments, the beam 111 is fixed. In the embodiment of FIGS. 2A-2B, the hydraulic cylinders 155 and 156 are configured to move the beams 112 and 113.

As shown in the expanded view 237, the hydraulic cylinder 155 may be connected to the beam 112 by the rod 153 and the joint 154. The hydraulic cylinder 155 may also be connected to the interior of the beam 111 by the rod 168 and the joint 169. The hydraulic cylinder 155 may be configured such that the rod 153 and the joint 154 may move towards the joint 169 in order to pull the beam 112 inside the hollow interior of the beam 111. The hydraulic cylinder 155 may be configured such that the rod 153 and the joint 154 may move away from the joint 169 in order to pull the beam 112 out of the hollow interior of the beam 111.

As shown in the expanded view 237, the hydraulic cylinder 156 may be connected to the beam 113 by the rod 158, the joints 159 and 178, and the pivot rod 177. The pivot rod 177 may be connected to the brackets 167. The hydraulic cylinder 156 may be connected to the interior of the beam 111 by the rod 157 and the joint 167. The hydraulic cylinder 156 may be configured such that the joint 159 may move towards the joint 167 in order to rotate the beam 113 around the pivot rod 177 towards the ground. The hydraulic cylinder 156 may be configured such that the joint 159 may move away from the joint 167 in order to rotate the beam 113 around the pivot rod 177 away from the ground. Other components of the truck 199 of FIGS. 2A-2B may be similar to the corresponding components of the truck 100 of FIGS. 1A-1B.

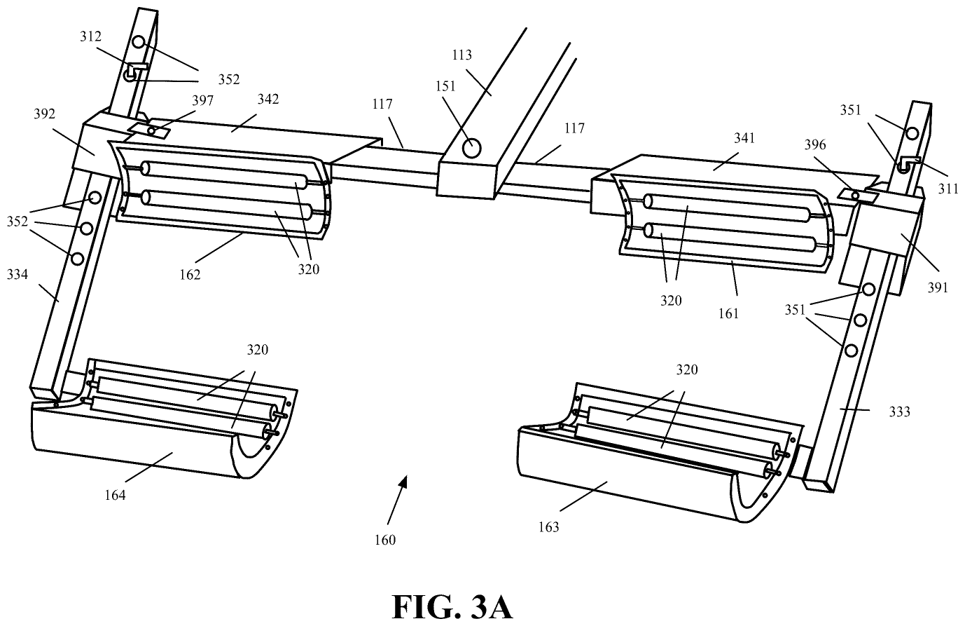

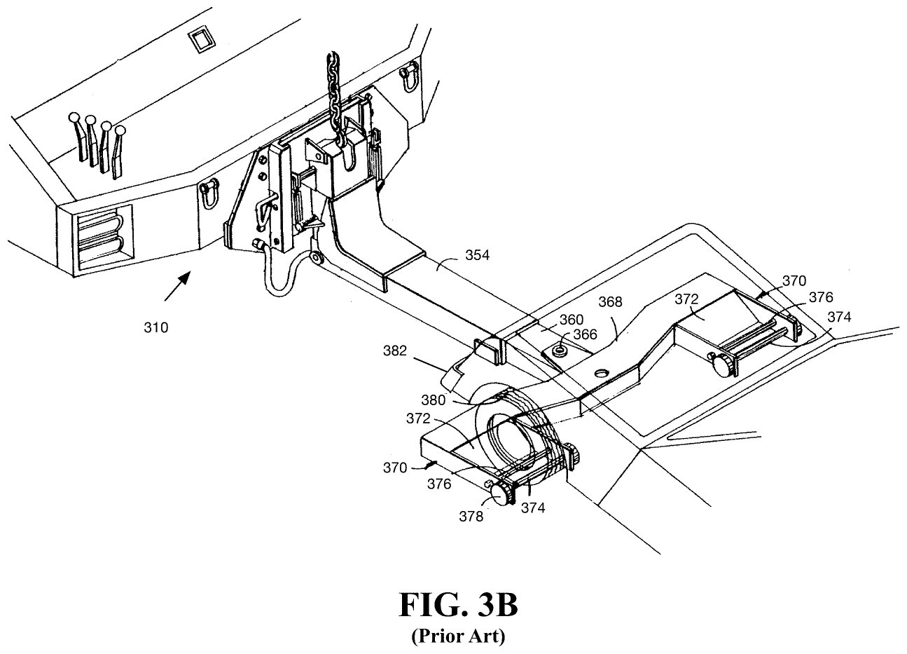

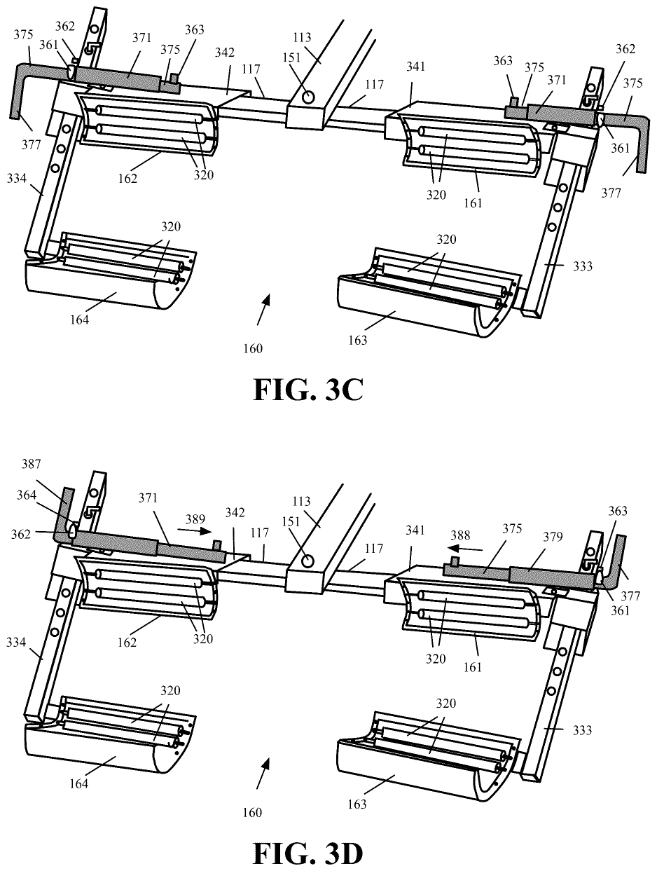

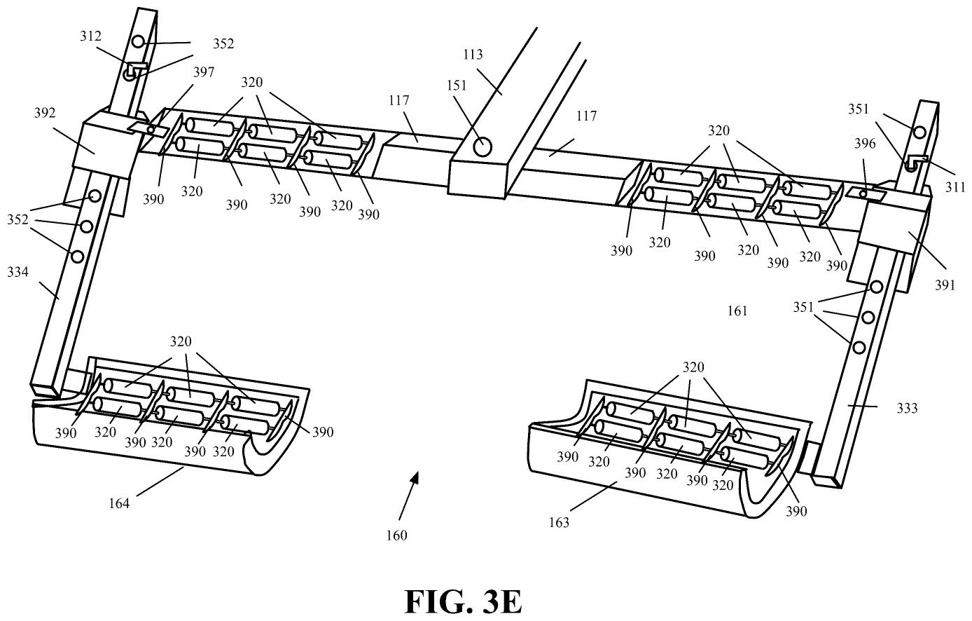

With further reference to FIGS. 1A-1B, the hydraulic wheel lift assemblies 101 and 102 may include the wheel retainer structures 160 and 170, respectively. The wheel retainer structures 160 and 170 may include the wheel retainers 161-164 and 171-173, respectively, for supporting the wheels of the vehicle being towed. The wheel retainer structure 170 may include the rods 193 and 194 (FIG. 1B) that may be inserted into the brackets 191 and 192, respectively. The rods 193 and 194 may include shafts that may be to attach to the towing wheels 133 and 134. In some embodiments, the wheel retainer structure 170 may include the spindles 143-144 to lift up the rods 193-194, respectively. In other embodiments, the rods 193-194 may be lifted by a jack to attach to the towing wheels 133-134, respectively. Further details of the wheel retainer structures used in the present embodiments are described with reference to FIGS. 3A, 3C-7, 10-11, 13-15, and 17.

FIG. 3A is a top perspective view of the wheel retainer structure of the first hydraulic wheel lift assembly 101 of a tow truck, according to various aspects of the present disclosure. With reference to FIG. 3A, the wheel retainer structure 160 may include the cross bar 117, the bars 341-342, the brackets 391-392, the pivots 396-397, the wheel retainers 161-164, the rods 333-334, and the pins 311-312.

The bars 341-342 may be configured to make telescopic movements against the cross bar 117 in order to adjust the width of the wheel retainer structure 160 to fit the width of different types of vehicles that are being towed. The cross bar 117 and the bars 341 and 342, in some embodiments, may have a substantially rectangular cross section. In the depicted embodiment, the cross bar 117 may have a smaller cross section that the bars 341-342 in order for the cross bar 117 to telescopically move in and out of the bars 341-342. In other embodiments, the bars 341-342 may have a smaller cross section than the cross bar 117 in order for the bars 341-342 to telescopically move in and out of the cross bar 117.

In some embodiments, the bars 341-342 may be fixedly connected to the wheel retainers 161 and 162, respectively. The brackets 391-392, in some embodiments, may be connected to the bars 341-342 by the pivots 396-397, respectively. The brackets 391-392 may be used to hold the rods 333 and 334, respectively. The pivots 396-397 may allow the brackets 391-392 to rotate against the bars 341-342, respectively in order to adjust the angels of the rods 333 and 334 (e.g., when one or both tires of the vehicle being towed is off alignment) or to allow the bars 343-344 to rotate against the bars 341-342, respectively, when the tow truck makes turns during the towing operation.

The rods 333 and 334 may be fixedly attached to the wheel retainers 163 and 164, respectively. The rod 333 may be moved through the bracket 391 in order to adjust the distance between the wheel retainers 161 and 163 to fit different sizes of the wheels of the vehicles being towed. The bar 334 may be moved through the bracket 392 in order to adjust the distance between the wheel retainers 162 and 164. Each of the brackets 391-392 may include two openings for allowing the corresponding rods 333 and 334 to go through. The openings that face the wheel retainers 163 and 164 may be configured to be wider than the opposite openings in order to allow the rods 363-334 and the wheels retainers 163-164 to move up and down by several inches during towing.

The rods 333 and 334 may include the holes 351-352, respectively. The pin 311 may be used to prevent the rod 333 from coming out of the bracket 391. The pin 312 may be used to prevent the rod 334 from coming out of the bracket 392. The rods 333-334 may be pulled out of the brackets 391-392, respectively, for example, and without limitations, when the tow truck is not being used to tow a vehicle. The rollers 320 and the wheel retainers 161-164, in some embodiments, may be configured such that they fit in the spaces between a vehicle's tires and the body of the vehicle. For example, the rollers 320, in some embodiments, may be approximately two inches thick.

FIG. 3B illustrates a wheel lift apparatus in the towing position, according to prior art. With reference to FIG. 3B, the prior art tow truck 310 includes a beam member 354 that telescopically receives a lifting arm 360. A yoke member 368, which includes the wheel receiving and supporting troughs 370, is pivotably connected at 366 to the lifting arm 360.

Each trough 370 includes a tire restraining member 372, rotatable tire mounts 374, 376, and drum members 378 that can roll along the ground into engagement with the tires 380 of a disabled vehicle 382. Accordingly, the tire mounts 374, 376, and drum members 378 of the prior art tow truck 310 are used to facilitate rolling the troughs 370 on the ground to engage with the tires 380. After the tire 380 is lifted off the ground, only the back side of the tire (i.e., the side that is farther from the tow truck 310) rests on the rotatable tire mounts 374, 376, while the front side of the tire (i.e., the side that is closer from the tow truck 310) rests on the non-rotatable tire restraining members 372. As such, once the tire 380 is lifted off the ground by the prior art tow truck 310, the tire 380 cannot rotate any further.

As described above, for an all-wheel drive vehicle, the other two wheels of the vehicle have to also be lifted and placed on towing wheels to prevent damage to the drivetrain of the vehicle during towing. However, in some situations, like when the vehicle is in a subterranean parking with a steep ramp, the portion of the vehicle that is over the towing wheels may not clear the ramp. In these situations, the two wheels that are placed over the towing wheels have to be put back on the ground and the vehicle has to be pulled up the ramp while the other two wheels are lifted by the tow truck. Since two of the wheels are on the ground and the other two wheels that are lifted by the prior art tow truck 310 cannot rotate, the drivetrain of the vehicle may be damaged.

In contrast, the wheel retainer structure of the first hydraulic wheel lift assembly 101 of the present embodiments include two sets of wheel retainers with rollers for each wheel being lifted. For example, the wheel retainer structure 160 shown in FIG. 3A includes the wheel retainers 161-164. The rollers 320 of the wheel retainers 161 and 163 engage one wheel of the vehicle that is being towed. The rollers 320 of the wheel retainers 161 engage the side of the wheel that is closer to the tow truck 100, and the rollers 320 of the wheel retainer 163 engage the side of the wheel that is farther to the tow truck 100.

Similarly, the rollers 320 of the wheel retainers 162 and 164 engage another wheel of the vehicle that is being towed. The rollers 320 of the wheel retainers 162 engage the side of the other wheel that is closer to the tow truck 100, and the rollers 320 of the wheel retainer 164 engage the side of the other wheel that is farther to the tow truck 100. Accordingly, both sides of each wheel that is lifted from the ground touches one or more rollers. The vehicle's wheels that are lifted are placed between two wheel retainers (e.g., the wheel retainers 161 and 163, or the wheel retainers 162 and 164) with rollers. When there is a need to lift only two wheels of an all-wheel drive vehicle from the ground and place the other two wheels on the ground and allow them to rotate, the two wheels that are lifted may also rotate over the rollers. The wheel retainer structure of the first hydraulic wheel lift assembly 101 of the present embodiments provides the technical advantage of preventing damage to the drivetrain of the all-wheel drive vehicle when the vehicle has to be towed over a distance with two of the wheels lifted and two of the wheels on the ground. Additionally, the pivots 396 and 397 provide the technical advantage of allowing the wheel retainers 163 and 164, and the vehicle's wheels that are engaged with the rollers of the wheel retainers 163 and 164, to turn left and right when the tow truck is making turns while towing the vehicle.

Some embodiments may include a pair of bars on wheel retainer structure of the first hydraulic wheel lift assembly 101 to prevent the wheels of a vehicle that is being towed from slipping out of the two wheel retainers that are engaging the wheels. FIGS. 3C and 3D are top perspective views of the wheel retainer structure of the first hydraulic wheel lift of a tow truck where a bar is used to prevent movements of the wheels of the vehicle being towed, according to various aspects of the present disclosure.

With reference to FIGS. 3C and 3D, the wheel retainer structure 160 may include two rotating L-shaped bars. Each L-shaped bar may include a rod 375 and a handle 377. The L-shaped bars may go through the hollow tubes 371 that may be fixed on the bars 341-342. A push pin 363 on each rod 375 may prevent the rod to fall off the corresponding tube 371. Each rod may have a cam 361, and each of the rods 333 and 334 may have a stopper pin 362. In FIG. 3C, the handles 377 are rotated such that the cams 361 are not engaged with the stopper pins 362.

In FIG. 3D, the rods 375 are moved in the direction of the arrows 388 and 389 towards the beam 113. The handles 377, in FIG. 3D, are rotated such that the cams 361 are engaged with the stopper pins 362 preventing the rods 375 to move through the tubes 379. The rods 375 may be configured to be spaced several inches above the bars 341-342, thereby preventing the vehicle's wheels to disengage from the rollers 320 if the tow truck rotates or hot bumps on the road.

FIG. 3E is a top perspective view of the wheel retainer structure of the first hydraulic wheel lift of a tow truck where the rollers are positioned inside the cross bar of the wheel retainer structure, according to various aspects of the present disclosure. With reference to FIG. 3E, a portion of the cross bar 117 on each side is open. In each opening, one or more rows of rollers 320 may be installed. In the depicted embodiment, there are two rows of rollers 320 on each side. Additionally, each row has several rollers 320. The rollers 320 in each row may be separated from each other by the spacers 390.

In the embodiment of FIG. 3E, the wheel retainers 163 and 164 also have two rows of rollers, each row with three rollers 320. The rollers 320 and the wheel retainers 163-164, in some embodiments, may be configured such that they fit in the spaces between a vehicle's tires and the body of the vehicle. For example, the rollers, in some embodiments, may be approximately two inches thick.

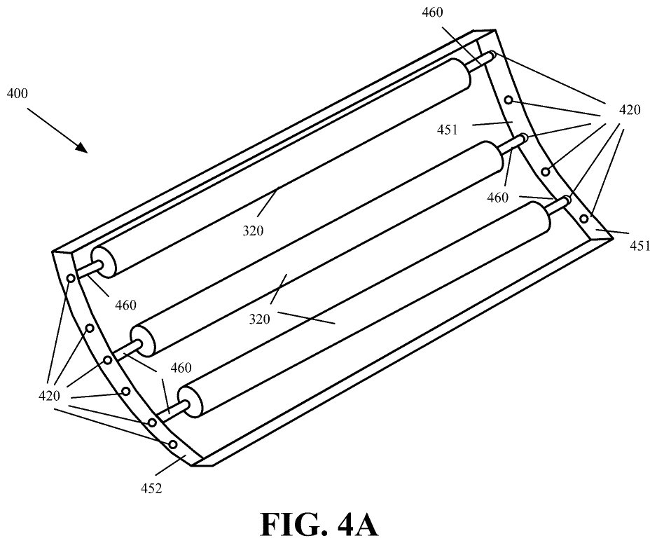

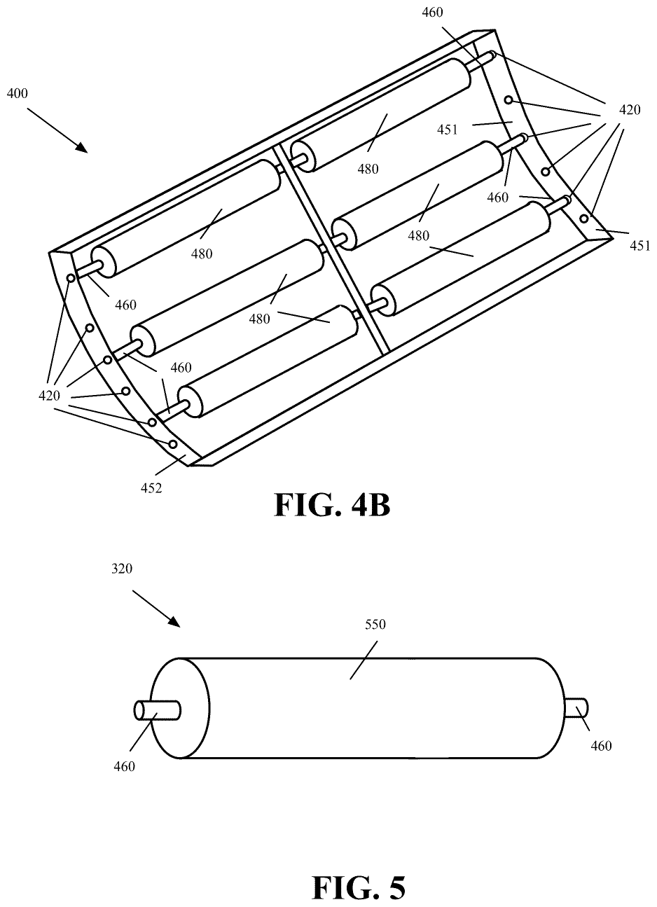

The wheel retainers 161-164, in some embodiments, may include a set of rollers 320 to allow the wheels of the vehicle being towed to rotate in place when the other two wheels of the vehicle are on the ground. FIG. 4A is a front perspective view of a wheel retainer 400 that includes a set of rollers 320, according to various aspects of the present disclosure. FIG. 5 is a front perspective view of a wheel retainer's roller 320, according to various aspects of the present disclosure.

With reference to FIG. 4A, the wheel retainer 400 may be any of the wheel retainers 161-164 and 171-174 of FIGS. 1A-1B, 3A, 3C-3E, and 7. The wheel retainer 400 may include one or more rollers 320. The wheel retainer 400, in some embodiments, may include several holes 420 on each side 451 and 452 for inserting rollers in the wheel retainer 400. With reference to FIGS. 4A and 5, the rollers 320 may include two rods 460 at each side of the roller 320 to insert the roller 320 into a pair of the holes 420 on the opposite ends of the wheel retainer 400.

The rollers'body 550 may be made, at least partly, of a durable material such as, for example, and without limitations, metal, rubber, carbon fiber, graphite, etc. The rollers 320 may be added to, or removed from, the wheel retainer 400 to fit a particular towing task. The wheel retainer 400 may have a curved shape to better fit around the wheel of a vehicle being towed. The wheel retainer 400, in the depicted embodiment, includes three rows of rollers, each row with one roller 320. In other embodiments, the wheel retainer may include a different number of rows (e.g., 1, 2, etc.) and/or may have different number of rollers per row.

FIG. 4B is a front perspective view of a wheel retainer 410 that includes more than one roller 480 per row, according to various aspects of the present disclosure. The wheel retainer 410 of FIG. 4B includes multiple rollers 480. The wheel retainer 410, in the depicted embodiment, includes two rollers 480 per row. The wheel retainer, in other embodiments, may include three or more rollers per row. The rollers 320 in FIG. 4A and the roller 480 in FIG. 4B may have a diameter that is configured to fit between the wheel and the body if different types of vehicles. For example, the rollers 320 or 480, in some embodiments may have a diameter between 2 to 3 inches to allow the rollers to fit in the tight space between the wheel and body of a vehicle.

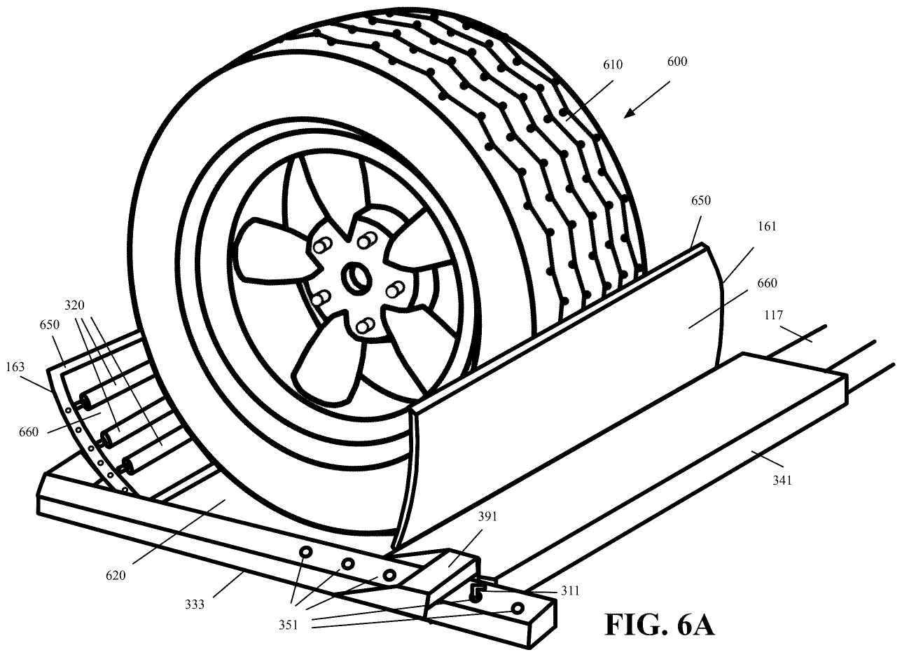

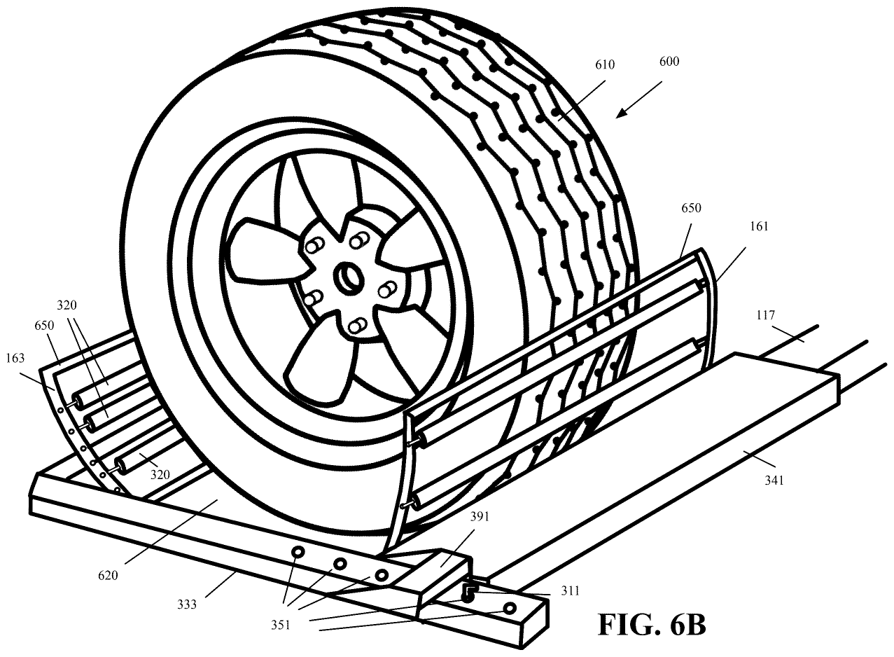

FIG. 6A is a front perspective view of a pair of wheel retainers fitted around the wheel 600 of a vehicle being towed, according to various aspects of the present disclosure. The example of FIG. 6A describes the pair of wheel retainers 161 and 163 of FIG. 3A. The discussion is similarly applicable to the wheel retainer pairs 162 and 164, 171 and 173, and/or 172 and 174 of FIGS. 1A-1B.

With reference to FIG. 6A, the wheel retainers 161 and 163 are shown while the wheel 600 of the vehicle being towed is still on the ground 620 (the rest of the vehicle being towed is not shown for clarity). The wheel retainer 161 may be placed against the tire 610 of the vehicle on the side of the tire 610 that faces the tow truck. The wheel retainer 163 may be placed against the tire 610 on the other side of the tire 610 that faces opposite the tow truck.

With further reference to FIG. 6A, the distance between the wheel retainers 161 and 163 may be adjusted by taking off the pin 311 and moving the rod 333 through the bracket 391. After the distance between the wheel retainers 161 and 163 is adjusted to fit around the tire 600, the pin 311 may be placed back in one of the holes 351 to prevent the rod 333 from coming off the bracket 391. In the embodiment of FIG. 6A, each of the wheel retainers 161 and 163 have a frame 650 and a curved plate 600, which may strengthen the frame. The rollers 320 are positioned between the two sides of each frame 650.

FIG. 6B is a front perspective view of a pair of wheel retainers, each with a frame and no plate, fitted around the wheel of a vehicle being towed, according to various aspects of the present disclosure. The wheel retainers 161 and 163 in FIG. 6B do not include the curved plates, which makes the wheel retainers 161 and 163 lighters. As shown in the example of FIG. 6B, the wheel retainers 161 and 163 may include different number of rollers. Additionally, the rollers 320 may not be uniformly spaced inside the frames 650.

The wheel retainers that include the rollers 320 provide the technical advantage of allowing the wheels that are being lifted to rotate in case the vehicle is all-wheel drive and the other two wheels have to be placed on the ground, at least for a period of time, during towing. The all-wheel drive vehicles are designed such that all four wheels of the vehicle must rotate together, otherwise the vehicle's drivetrain may be damaged.

In some situations, it may be necessary to tow an all-wheel drive vehicle for a distance while two of the wheels are on the ground. As an example, when the vehicle is in a subterranean parking with a steep ramp, a flatbed tow truck may not be used as the vehicle placed on top of the tow truck may not clear the ramp. Using a wheel-lift tow truck to lift two of the vehicle's wheels and placing the other two wheels on towing wheels may not be possible as the portion of the vehicle that is over the towing wheels may not clear the ramp. In these situations, the two wheels that are placed over the towing wheels have to be placed on the ground and the vehicle has to be pulled up the ramp while two of the vehicle's wheels are lifted and other two wheels are on the ground. If the wheels that are lifted cannot rotate, the drivetrain of the vehicle may be damaged.

Using the wheel retainers of the present embodiments that include rollers allows the two wheels that are lifted to rotate over the rollers at the same time that the two wheels that are on the ground rotate, without damaging the drivetrain of the vehicle. Once the vehicle is towed over the ramp, the two wheels that are on the ground may be placed back over the towing wheels. The wheel retainers of the present embodiments that include rollers may be used by the traditional tow trucks that only have one hydraulic wheel lift as well as the tow trucks of the present embodiments that include two hydraulic wheel lifts.

FIG. 7 is a top perspective view of the wheel retainer structure 170 of the second hydraulic wheel lift assembly 102 that may be used for attaching towing wheels, according to various aspects of the present disclosure. With reference to FIG. 7, the wheel retainer structure 170 may include the cross bar 127, the bars 141-142, the brackets 191-192, the wheel retainers 171-174, the rods 193-194, the shafts 771-772, the pins 711-712, the spindles 143-144, and the towing wheels 133-134.

The beam 123 may be fixedly attached to the cross bar 127. The bars 141-142 may be configured to make telescopic movement against the cross bar 127 in order to adjust the width of the wheel retainer structure 170 to fit the width of different types of vehicle being towed. The cross bar 127 and the bars 141 and 142, in some embodiments, may have a substantially rectangular cross section. In the depicted embodiment, the cross bar 127 may have a smaller cross section than the bars 141-142 in order for the cross bar 127 to telescopically move in and out of the bars 141-142. In other embodiments, the bars 141-142 may have a smaller cross section than the cross bar 127 in order for the bars 141-142 to telescopically move in and out of the cross bar 127.

In some embodiments, the bars 141-142 may be fixedly attached to the wheel retainers 171 and 172, respectively. The brackets 191-192, in some embodiments, may be fixedly attached to the bars 141-142, respectively. The brackets 191-192 may be used to hold the rods 193 and 194, respectively. The rods 193 and 194 may be fixedly attached to the wheel retainers 173 and 174, respectively.

Each of the brackets 191 and 192 may include two openings for allowing the corresponding rods 193 and 194 to go through. The openings that face the wheel retainers 173 and 174 may be configured to be wider than the opposite openings in order to allow the rods 193-194 and the wheels retainers 173-174 to move up and down by several inches during towing. The rod 193 may be moved through the bracket 191 in order to adjust the distance between the wheel retainers 171 and 173 to fit different sizes of the wheels of the vehicles being towed. The rod 194 may be moved through the bracket 192 in order to adjust the distance between the wheel retainers 172 and 174

The rods 193 and 194 may include the holes 751-752, respectively. The pin 711 may be used to prevent the rod 193 from coming out of the bracket 191. The pin 712 may be used to prevent the rod 194 from coming out of the bracket 192. The rods 193-194 may be pulled out of the brackets 191-192, respectively, for example, and without limitations, when the tow truck is not being used to tow a vehicle. The rods 193-194, the wheel retainers 173-174, and/or the towing wheels 173-174 may be detached from the hydraulic wheel lift assembly 102 and stored on the bed or on the sides of the tow truck. For example, FIG. 1A shows the towing wheel 133, the rod 193, the wheel retainer 173, and the rod's attachments are stored on one side of the tow truck 100.

With further reference to FIG. 7, the wheel retainers 171-174, in some embodiments, may include a set of rollers 320, which may be similar to the roller 320, described above with reference to FIGS. 4A, 4B, and 5. The rods 193 and 194 may include the shafts 771-772, respectively. The shafts 771-772 may be used to connect the towing wheels 133-134 to the rods 193 and 194, respectively. The shafts 771-772 may be configured such that the towing wheels 133-134 may be attached and detached to the shaft by quick release mechanisms, such as, for example, and without limitations, twist and lock mechanisms, pins and hole mechanism, etc.

The wheel retainer structure 170, in some embodiments, may include the spindles 143-144 that are connected to the rods 193 and 194, respectively. The spindles 143-144 may be used to quickly lift the rods 193 and 194 above the ground. The spindles 143-144, in some embodiments, may provide a similar functionality as the spindles of the traditional towing dollies.

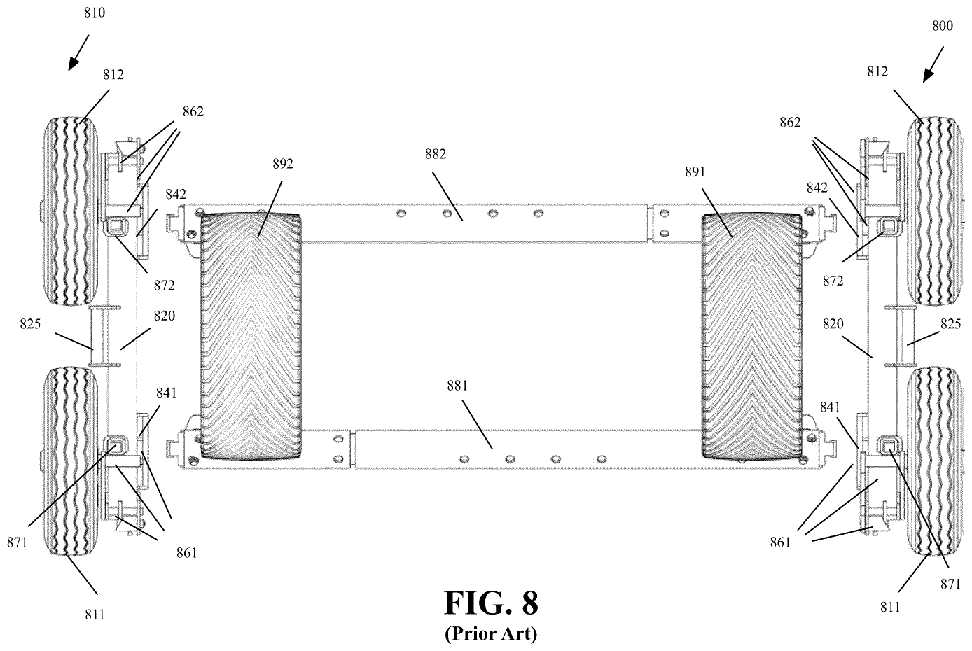

FIG. 8 is functional diagram illustrating an example use of two tow dollies for lifting a pair of wheels of a vehicle, according to prior art. The figure shows two tow dollies 800 and 810 that are placed on either sides of a vehicle to be towed. For clarity, only the two wheels 891-892 of the vehicle being towed are shown. The two wheels 891-892 are the pair of the vehicle's wheels that are farther from the tow truck. The two wheels 891-892 may be lifted by the two tow dollies 800 and 810 while the other two wheels (not shown) of the vehicle that are closer to the tow truck may be lifted by the tow truck's hydraulic wheel lift.

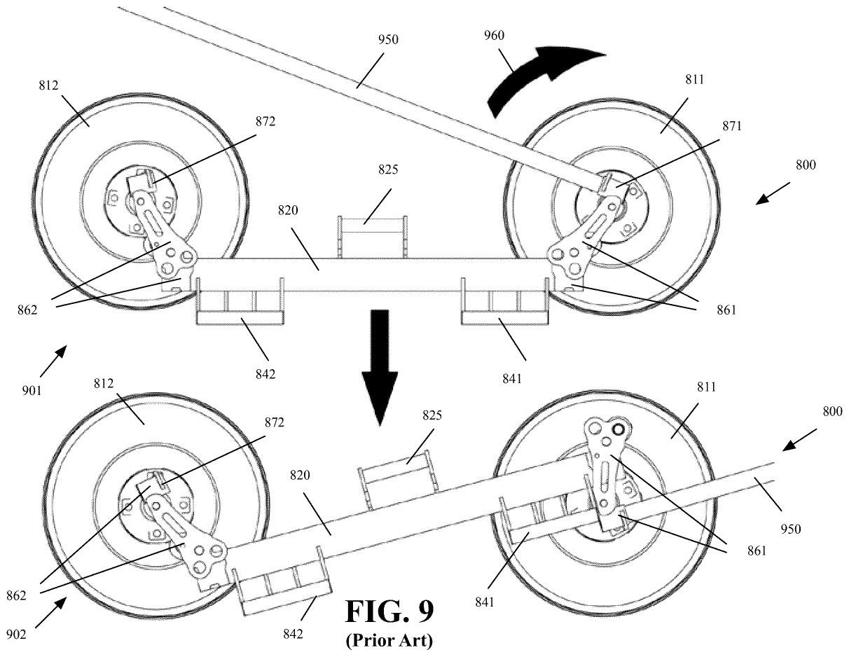

Each of the two tow dollies 800 and 810 may include two wheels 811-812, a frame 820, a handle 825, two axel cradles 841-842, and two spindles 861-862. To prepare the vehicle for towing, the two tow dollies 800 and 810 have to be picked up (e.g., by the corresponding handles 825) from the tow truck and placed on either sides of the vehicle. The two axels 881-882 have also to be picked up from the tow truck and placed under the vehicle to touch the two wheels 891-892. For each tow dolly 800 and 810, the two axels 881-882 have to be engaged into the two axel cradles 841-842, respectively, to lift up the wheels 891-892. Each spindle 861-862 may include an anchor 871-872, respectively. The anchors 871-872 may be used for placing a lever to lift the corresponding side of the tow dolly, as described below with reference to FIG. 9.

FIG. 9 is functional diagram illustrating the operation of the tow dolly 800 of FIG. 8, according to prior art. The figure, as shown, includes two operational stages 901-902. In stage 901, the two axel cradles 841-842 may be placed on the ground. One side of each axel 881-882 (FIG. 8) may be inserted into the axel cradles 841-842, respectively. The lever 950 may then be inserted into the anchor 871 of the spindle 861 and may be rotated in the direction of the arrow 960.

As shown in stage 902, as the lever 950 is rotated, the axel cradle 841 and the side of the frame 820 that is connected to the spindle 861, may be lifted off the ground. The same operation may be repeated by inserting the lever 950 into the anchor 872 of the spindle 862 and rotating the lever 950 in the opposite direction of the arrow 960 to lift the axel cradle 842 and the side of the frame 820 that is connected to the spindle 862 off the ground.

When the axels 881-882 (FIG. 8) are inserted into the axel cradles 841-842, lifting the axel cradles 841-842 and the frame 820 of the dolly 800 may cause the wheel 891 (FIG. 8) of the vehicle being towed to be lifted off the ground. The same operation may be repeated for the dolly 810 of FIG. 8 to lift the wheel 892 off the ground.

Setting up the prior art tow dollies of FIGS. 8-9 to lift the wheels of a vehicle may be time consuming. The setting up may require placing the two axels 881-882 underneath the vehicle on each side of the pair of wheels 891-892 that are going to be lifted up by the tow dollies (which are the pair of wheels that are farther from the tow truck during towing). The axels 881-882 then have to be extended to span the width of the vehicle. Each of the tow dollies 800 and 810 has to be connected to each side of the axels. The tow dollies then have to be secured by passing ratchet straps behind the vehicle's wheels and attaching the hook ends of the straps to the tow dollies. A lever is then used to rotate the spindles and lift of the wheels, as described above with reference to FIGS. 8-9.

In addition to the time consuming setup, the tow dollies and the axels are heavy. For example, each tow dolly may weight more than 50 pounds. Each time a vehicle is being towed, the tow truck driver has to pick up the two tow dollies and the two axels. The tow dollies have to be placed on each side of the car and have to be connected to each other by the two axels that extended below the frame of the car. After the towing is done, the tow dollies and the axels have to be picked up and placed back on the tow truck. Repeatedly lifting the tow dollies and the axels from the tow truck and placing them back may cause back or other types of injuries to the tow truck driver.

Another alternative in the prior art tow trucks for lifting a vehicle's wheels that are farther from the tow truck is using a jack. The jack may be used to lift each side of the vehicle followed by putting axels underneath the vehicles wheels, and putting the towing wheels underneath the wheel (similar to the setup of FIG. 8, except a jack is used to lift the wheels). Using a jack may be even for time consuming that using the tow dollies. The jack, the axels, and towing wheels may be heavy and repeated use of them may also result in injuries to the tow truck personnel.

Referring back to FIG. 1B, the tow trucks of the present embodiments solve the above-mentioned problems of the prior art tow trucks, tow dollies, and/or jacks by providing the second hydraulic lift assembly 102 that eliminates the need for the above-mentioned axels, tow dollies, and/or jacks. The first hydraulic wheel lift assembly 101 may be used as a traditional hydraulic wheel lift assembly 101 to lift the two wheels of a vehicle that are closer to the tow truck. The second hydraulic wheel lift assembly 102 may then extend below the first hydraulic wheel lift assembly 101 (e.g., as shown in FIG. 1C) to reach the two wheels of the vehicle 175 that are farther from the tow truck 100.

With further reference to FIG. 1B, the crossbar 127 and the bars 141-142 eliminate the need for the prior art axels 881-882 of FIG. 8. The crossbar 127, the bars 141-142, and the wheel retainers 171-172 are fixedly attached to the second hydraulic wheel lift 102 and the tow truck driver does not have to lift them up and attach them to the second hydraulic wheel lift 102. The driver of the tow truck 100 of the present embodiments only has to insert the rod 193 (and the attached spindle 143 and the wheel retainer 173) into the bracket 191, to insert the rod 194 (and the attached spindle 144 and the wheel retainer 174) into the bracket 192, and then attach the towing wheels 133 and 134 to the rods 193-194, respectively.

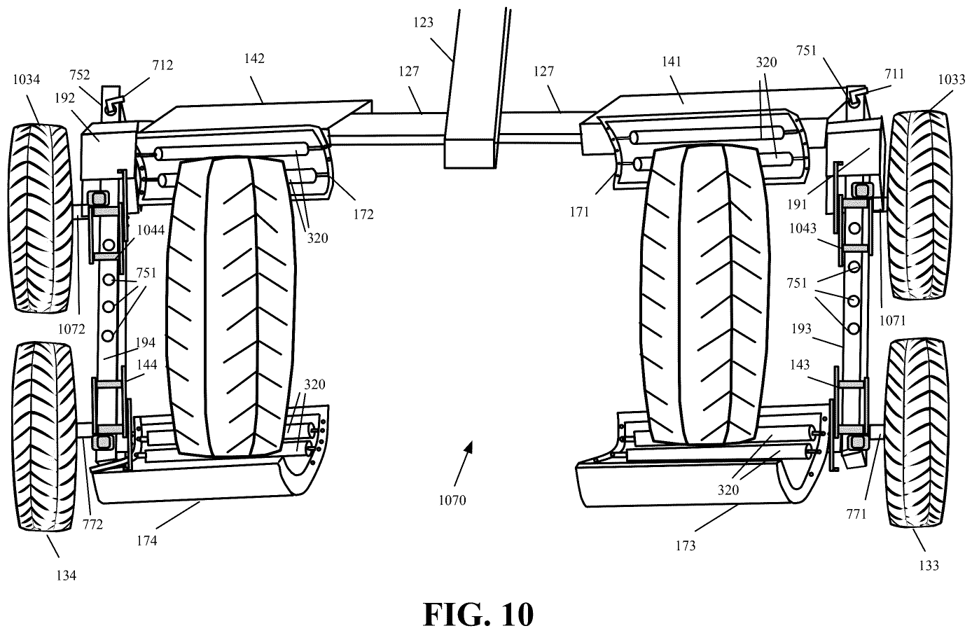

In some embodiments, the wheel retainer structure of the second hydraulic wheel lift may include two towing wheels on each side. FIG. 10 is a top perspective view of the wheel retainer structure of the second hydraulic wheel lift assembly with two towing wheels on each side of the wheel retainer structure, according to various aspects of the present disclosure. With reference to FIG. 10, the wheel retainer structure 1070 may include the cross bar 127, the bars 141-142, the brackets 191-192, the wheel retainers 171-174, the rods 193-194, the shafts 771-772, the pins 711-712, the spindles 143-144, and the towing wheels 133-134, which may provide similar functionality as the corresponding components of FIG. 7.

In addition, the wheel retainer structure 1070 may include the spindles 1043-1044, the shafts 1071-1072, and the towing wheels 1033-1034. The shafts 1071-1072 may be used to attach the towing wheels 1033-1034 to the rods 193 and 194, respectively. The shafts 1071-1072 may be configured such that the towing wheels 1033-1034 may be attached and detached to the shaft by quick release mechanisms, such as, for example, and without limitations, twist and lock mechanisms, pins and hole mechanism, etc.

The wheel retainer structure 1070, in some embodiments, may include the spindles 1043-1044 that are connected to the rods 193 and 194. The spindles 1043-1044 may be used to quickly lift the corresponding sides of the rods 193 and 194 above the ground. The spindles 1043-1044, in some embodiments, may work similar to the spindles of the traditional towing dollies, described above with reference to FIGS. 8-9.

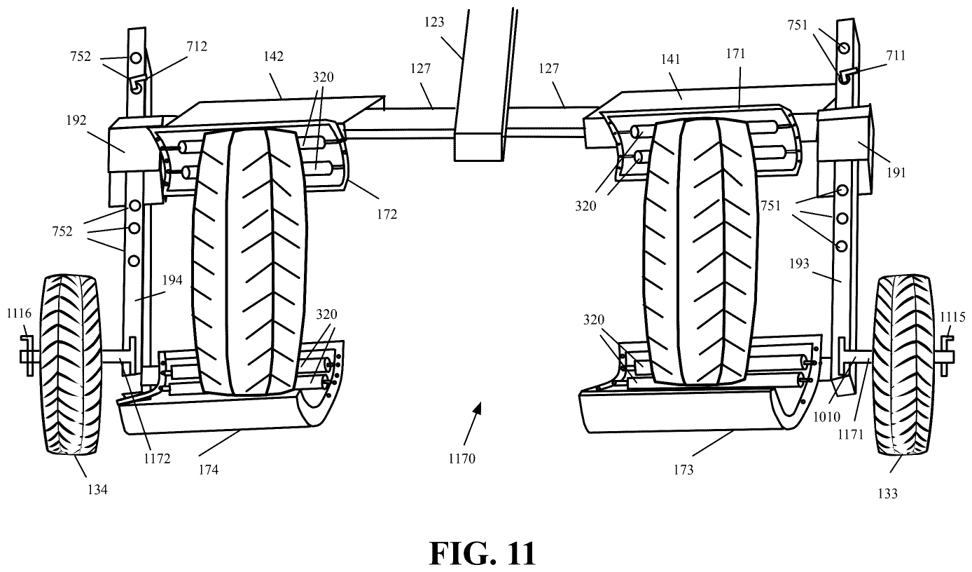

In some embodiments, the wheel retainer structure of the second hydraulic wheel lift may not include spindles. FIG. 11 is a top perspective view of the wheel retainer structure of the second hydraulic wheel lift with one towing wheel on each side of the wheel retainer structure and no spindles, according to various aspects of the present disclosure. With reference to FIG. 11, the wheel retainer structure 1170 may include the cross bar 127, the bars 141-142, the brackets 191-192, the wheel retainers 171-174, the rods 193-194, the pins 711-712, and the towing wheels 133-134, which may provide the similar functionality as the corresponding components of FIG. 7.

With reference to FIG. 11, the wheel retainer structure 1170 may not include any spindles (such as the spindles 143-144 of FIG. 7). The rods 193-194 may include the shafts 1171-1172 that may include a quick release mechanism, such as, for example, and without limitations, the pins 1115-1116, respectively. The bars 193-194 may be lifted by a jack, the wheels 133-134 may be attached to the shafts 1171-1172, and the pins 1115-1116 may be used to secure the wheels 133-134 to the shafts 1171-1172, respectively.

In the embodiment of FIGS. 1A-1B, the second hydraulic wheel lift assembly 102 has a lower height than the first hydraulic wheel lift assembly 101. The second hydraulic wheel lift assembly 102, in this embodiment, extends through the recess 135 in the bed 130 of the tow truck 100. In other embodiments, the two hydraulic wheel lifts of the tow trucks of the present embodiments may be positioned differently on the tow truck's bed and/or may have a different profiles than the embodiment of FIGS. 1A-1B.

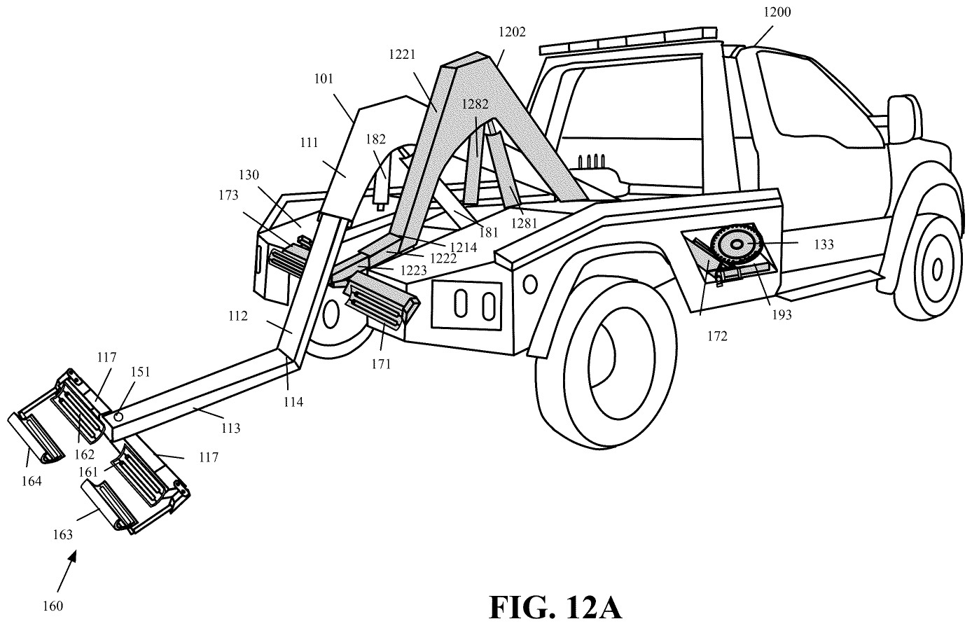

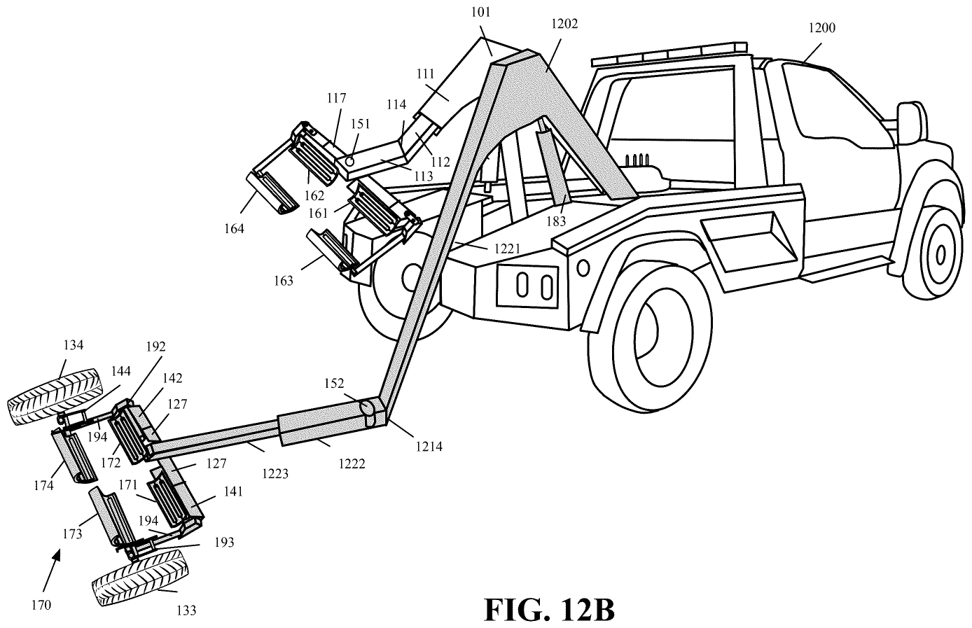

FIGS. 12A-12B are side perspective views of an alternative embodiment of a tow truck with a first hydraulic wheel lift assembly for lifting a first pair of wheels of a vehicle and a second hydraulic wheel lift assembly for attaching the second pair of wheels of the vehicle to towing wheels, according to various aspects of the present disclosure. With reference to FIGS. 12A-12B, the first hydraulic wheel lift assembly 101 may be similar to the first hydraulic wheel lift assembly 101 of FIGS. 1A-1B. The second hydraulic wheel lift assembly 1202 of FIGS. 12A-12B may extend above the bed 130 of the tow truck 1200.

The second hydraulic wheel lift assembly 1202 may have the beams 1221-1223. The two hydraulic cylinders 1281-1282 may be configured to move the second hydraulic wheel lift assembly 1202 up, down, forward, backward, and sideways. Other embodiments may include fewer or more than two hydraulic cylinders for moving the second hydraulic wheel lift assembly 1202. The hydraulic wheel lift assembly 1202 may include several beams 1221-1223. The beams 1221-1223, in some embodiments, may have substantially rectangular cross sections. At least some of the beams, such as the beam 1222 may be hollow to facilitate a telescopic movement. In the example of FIGS. 12A-12B, the beams 1222 and 1223 are telescopic, with the beam 1223 having a smaller cross section than the beam 1222.

The hydraulic wheel lift assembly 1202 may include a hinge (or movable joint) 1214 between the beams 1221 and 1222 to allow the beams 1221 and 1222 to move at an angle and tilt against each other. In the example of 12A-12B, the hydraulic wheel lift assembly 1202 is shown to include three beams 1221-1223, where the beam 1223 telescopically moves in and out of the beam 1222 and the beam 1222 may rotate around the hinge 1214 against the beam 1221. In other embodiments, the hydraulic wheel lift assembly 1202 may include fewer or more than three beams, may include more than two telescopic arms, may include more than two arms with hinges between them, may include no telescopic arms, or may include no hinges between the arms.

It should be noted that the hydraulic wheel lift assembly 101 of the truck 1200 of FIGS. 12A-12B, in some embodiments, may be similar to the hydraulic wheel lift assembly 101 of the truck 199 of FIGS. 12C-12D. For example, the hydraulic wheel lift assembly 101 of the truck 1200 may not include the hydraulic arms 181-182 and instead may include the 155 hydraulic cylinders 155 and 156 of FIGS. 2A-2B, and may operate as the hydraulic wheel lift assembly 101 of the truck 199, as described above with reference to FIGS. 2A-2B.

As described above, the rollers 320 used on the wheel retainers 161-164 provide the technical advantage of allowing the two wheels of an all-wheel vehicle that are lifted by the first hydraulic wheel lift to rotate when the other two wheels are on the ground and are rotating during towing. The rollers used on the wheel retainers 171-174 of FIGS. 7 and 10-11 provide the advantage of allowing the wheel retainers of the first hydraulic wheel lift assembly and the second hydraulic wheel lift assembly to be used interchangeably, if needed.

Despite the advantages provided by the rollers 320, the tow trucks of the present embodiments may use wheel retainers that do not include rollers. For example, some or all the wheel retainers of FIGS. 3A, 3C-7, and 10-11, in some embodiments, may have the same shape as depicted in the corresponding figures without including any rollers 320.

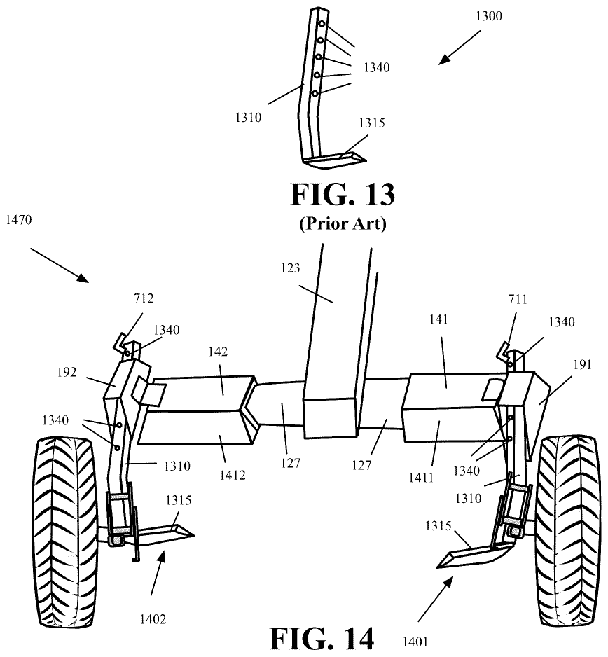

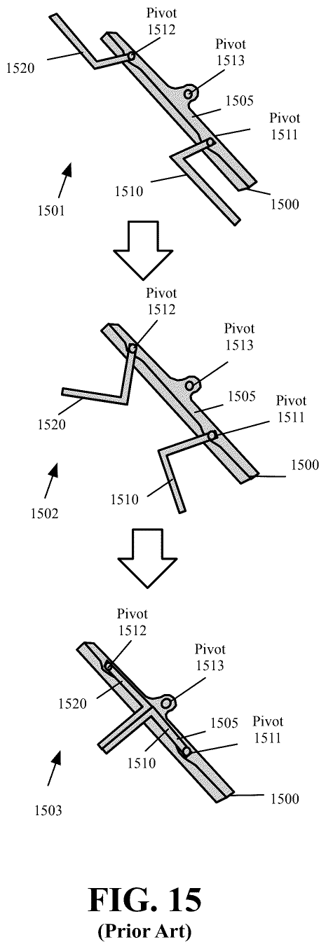

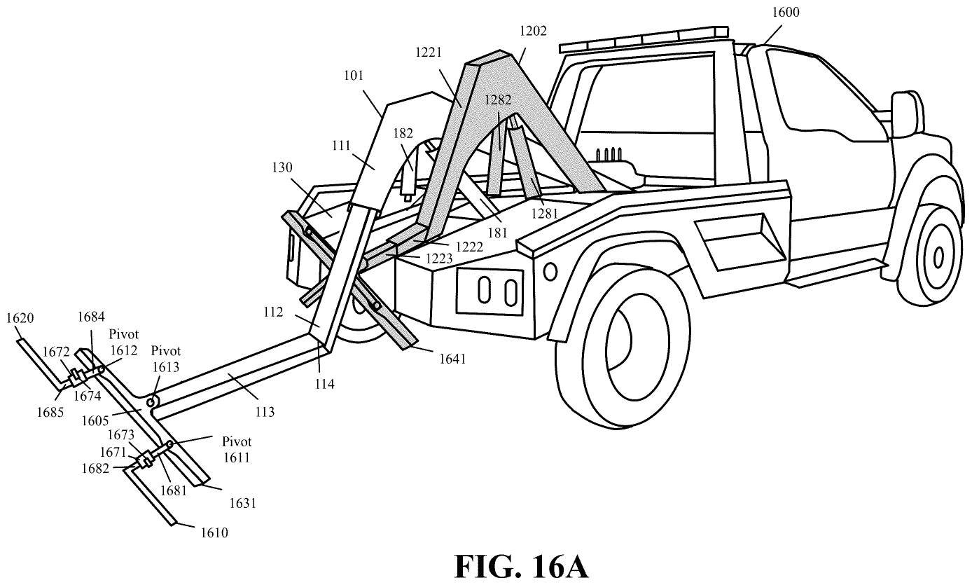

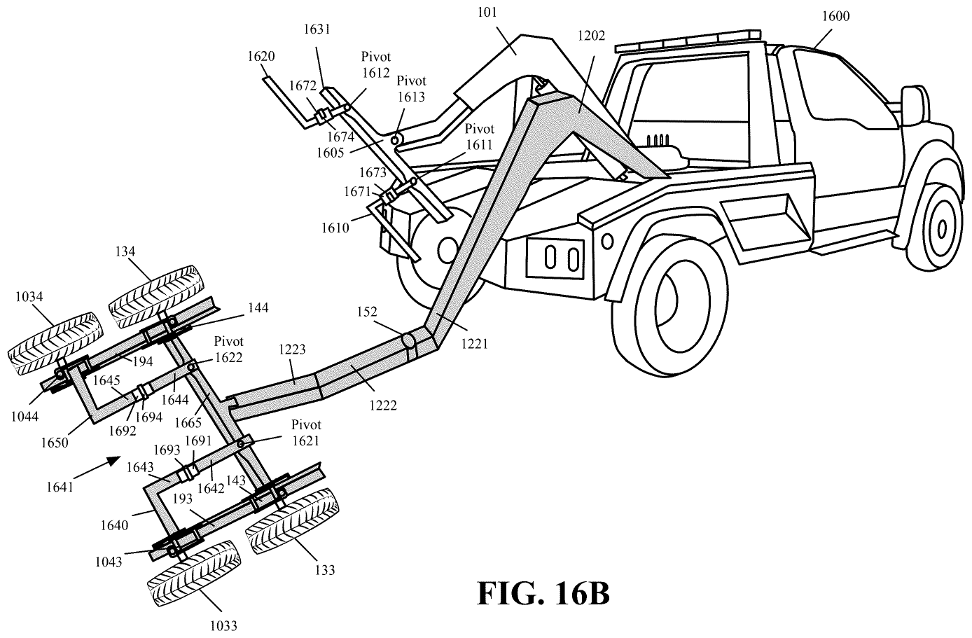

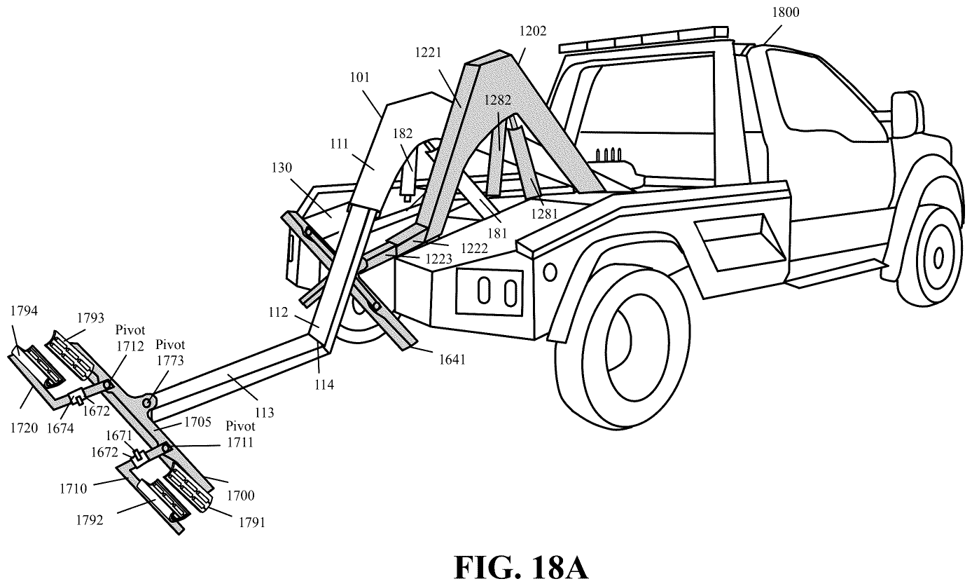

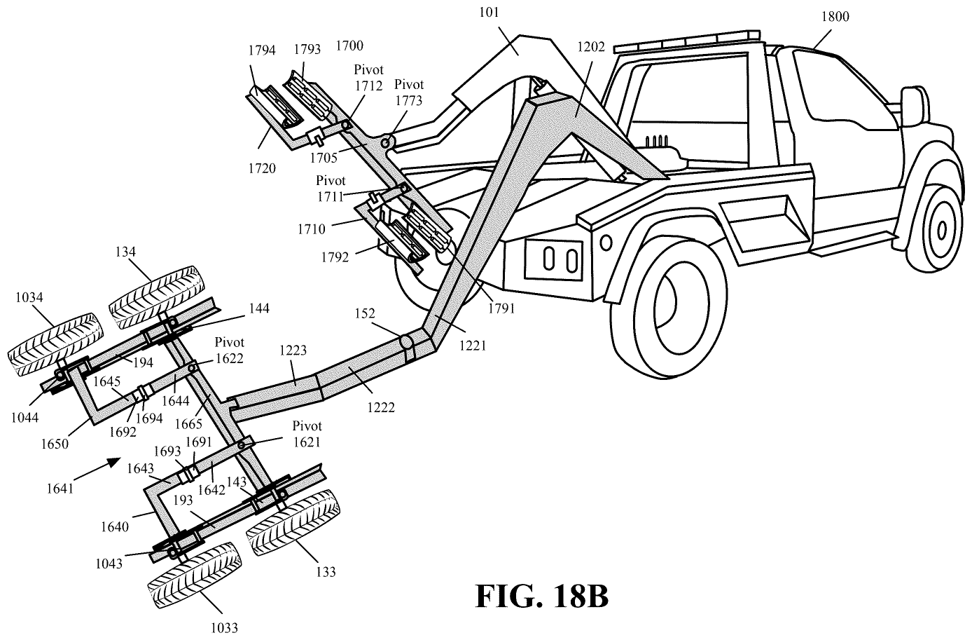

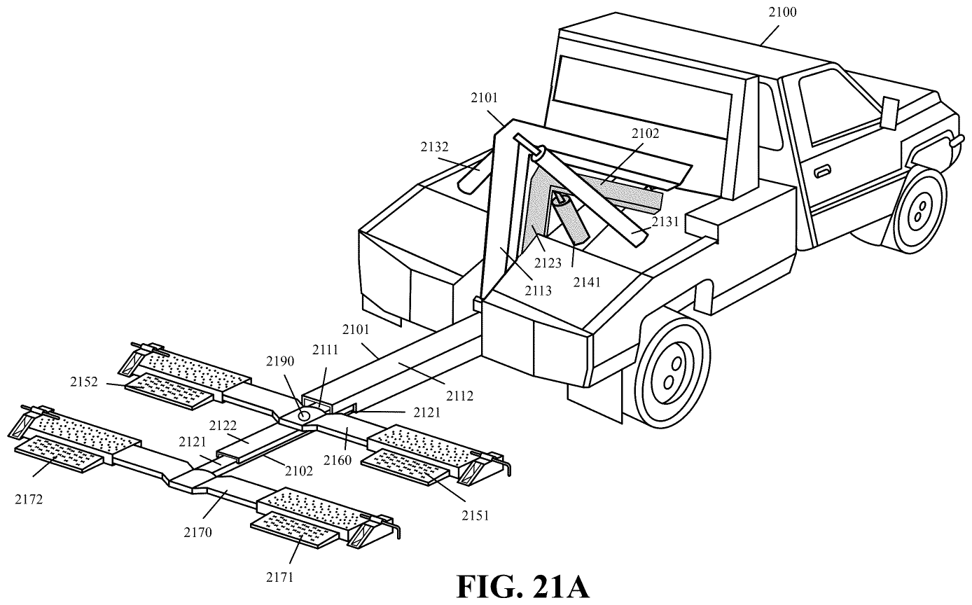

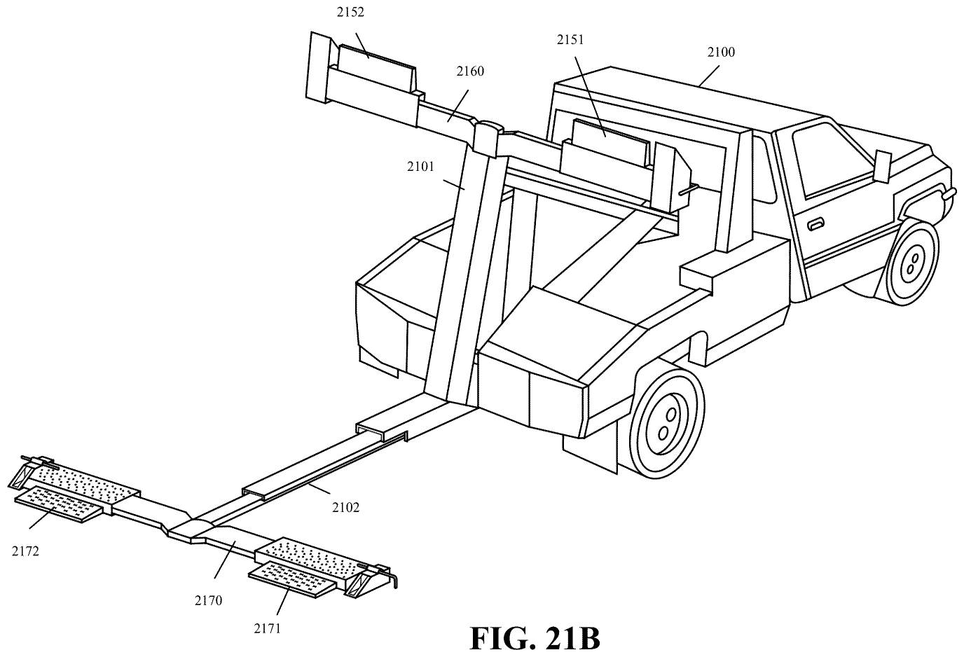

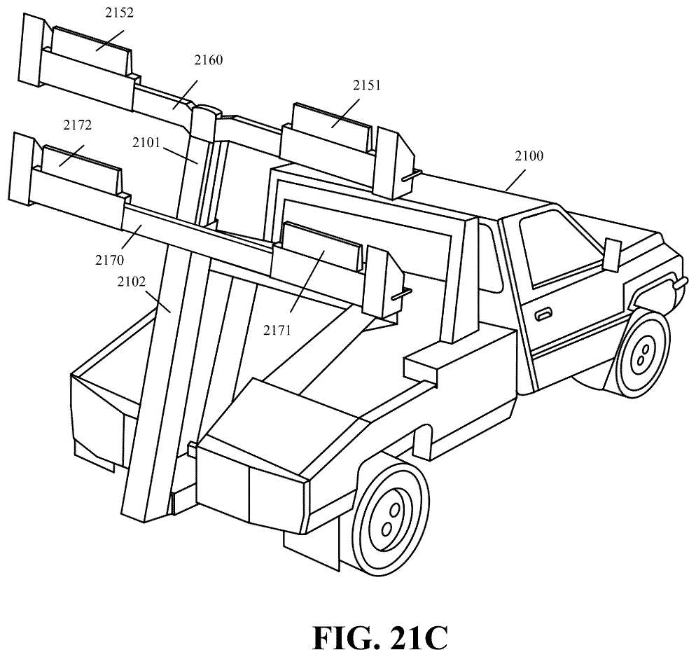

The tow trucks of the present embodiments may also use prior art wheel retainers for one or both of the hydraulic wheel lift assemblies. For example, and without limitations, as described below, the present embodiments may use the wheel retainers 1300 (FIGS. 13), 1401, 1402, 1411, 1412 (FIGS. 14), 1500 (FIGS. 15), 1631, 1641 (FIGS. 16A-16B), 1641 (FIGS. 18A-18B), and/or 2151, 2152, 2171, 2172 (FIGS. 21A-21C) and still provide the technical advantage of having two hydraulic lifts to facilitate towing vehicles, as described herein. Several examples of prior art wheels retainers that may be used in the tow trucks of the present embodiments are described below.

FIG. 13 illustrates a front perspective view of a tow truck wheel retainer, according to prior art. With reference to FIG. 13, the wheel retainer 1300 may be L-shaped with an arm 1310 that may be inserted into a bracket and an arm 1315 that may hold one side of a wheel of a vehicle that is being towed. The holes 1340 may be used to insert a pin to prevent the wheel retainer 1300 to come out of a bracket, as described below with reference to FIG. 14.

FIG. 14 illustrates a top perspective view of a tow truck wheel retainer structure 1470, according to various aspects of the present disclosure. The example of FIG. 14 is described with reference to the truck wheel retainer structure of the second hydraulic lift assembly. It should be noted that a similar discussion applies to the wheel retainer structure of the first hydraulic lift assembly, except that no wheels are attached to the wheel retainers of the first hydraulic wheel lift assembly.

As shown in FIG. 14, the wheel retainer structure 1470 may include two types of wheel retainers. The L-shaped wheel retainers 1401 and 1402 and the slanted wheel retainers 1411 and 1412, with each slanted wheel retainer 1411 or 1412 being a slanted surface. Each pair of one L-shaped wheel retainer and one slanted wheel retainer (1401/1411 and 1402/1412) may be used to hold one wheel of the vehicle being towed, with the L-shaped wheel retainer in each pair contacting the side of wheel that is farther from the tow truck and the slanted wheel retainer in the pair contacting the side of the wheel that is closer to the towing truck.

The cross bar 127 may be attached to the bars 141-142. The bars 141-142, in some embodiments, may have a substantially rectangular cross section with the slanted wheel retainers 1411-1412 attached to sides of the bars 141-142 that face the wheel of the vehicle being towed. The bars 141-142 may be hollow and the cross section of the bars 141-142 may be configured such that the cross bar 127 telescopically move into and out of the bars 141-142 for adjusting the width of the wheel retainer structure 1470.

In other embodiments, the bars 141-142 may have a polygon shape cross section with slanted sides 1411-1412, respectively. The polygon cross section of the bars 141-142, in these embodiments, may be configured such that the cross bar 127 may telescopically move into and out of the bars 141-142 for adjusting the width of the wheel retainer structure 1470.

With further reference to FIG. 14, the bars 141-142 may be fixedly attached to the brackets 191-192, respectively. The L-shaped wheel retainer 1401 and 1402 may be similar to the L-shaped arm 1300 of FIG. 13. The L-shaped wheel retainer 1401 and 1402 may be inserted into the brackets 191-192, respectively. The arms 1310 of each L-shaped arms of the wheel retainer 1401 and 1402 may be moved inside the brackets 191-192, respectively to adjust to the sizes of the wheels of different vehicles being towed. The holes 1340 and the pins 711-712 may be used to prevent the L-shaped wheel retainer 1401 and 1402 to come out of the brackets 191-192, respectively.

To prepare a vehicle's wheels for lifting, the hydraulic wheel lift may be lowered such that the slanted surfaces 1411 and 1412 touch the side of wheel that is closer to the tow truck. The arm 1315 of each L-shaped wheel retainer 1401 and 1402 may then be placed on the opposite side of the wheel. The other arm 1410 of each L-shaped wheel retainer 1401 and 1402 may be inserted into the corresponding bracket 191-192. The length of the arms 1410 that go through the brackets 191-192 may be adjusted to hold a tight grip on the wheel such that the wheel may not be able to turn.

Some embodiments may use wheel retainers that include a cross bar and two L-shaped bars. FIG. 15 illustrates a top perspective view of a tow truck wheel retainer with a cross bar and two L-shaped bars, according to prior art. With reference to FIG. 15, the wheel retainer 1500 may have a cross bar 1505 with two L-shaped bars 1510 and 1520. The two sections of each L-shaped bar 1510 and 1520 may intersect each other at a substantially 90 degrees angel. The two L-shaped bars 1510 and 1520 may be attached to the cross bar 1505 by the pivots 1511-1512, respectively. The two L-shaped bars 1510 and 1520, in some embodiments, may be attached to the cross bar 1505 by rotating plates (not shown) or by a small hydraulic arms (not shown) that may connect the L-shaped bars 1510 and 1520 to the cross bar 1505.

FIG. 15, as shown, includes three operational stages 1501-1503. In stage 1501, the L-shaped bars 1510 and 1520 are extended, for example, to hold against the wheels of a car being towed. In stage 1502, the two L-shaped bars 1510 and 1520 are being rotated around the pivots 1511-1512, respectively. In stage 1503, the two L-shaped bars 1510 and 1520 are folded over the cross bar 1505, for example, after the completion of a towing task.

FIGS. 16A-16B are side perspective views of a tow truck 1600 with two hydraulic wheel lift assemblies where each hydraulic wheel lift assembly may be attached to a wheel retainer with a cross bar and two L-shaped bars, according to various aspects of the present disclosure. The tow truck 1600 includes a first hydraulic wheel lift assembly 101 and a second hydraulic wheel lift assembly 1221, which may be similar to the hydraulic wheel lift assemblies 101 and 1221 of FIGS. 12A-12B.

With reference to FIGS. 16A-16B, the first hydraulic wheel lift assembly 101 may include the wheel retainer 1631, which may be similar to the wheel retainer 1500 of FIG. 15. The wheel retainer 1631 may include the cross bar 1605, the L-shaped bars 1610 and 1620, which may be connected to the cross bar 1605 by the pivots 1611 and 1612, respectively. The cross bar 1605 may be connected to the bar 113 of the first hydraulic wheel lift 101 by the pivot 1613.

The length of the L-shaped bars 1610 and 1620, in some embodiments, may be adjustable. As shown in FIG. 16A, the L-shaped bar 1610 may include two sections 1681 and 1682. One of the sections, for example, section 1681 may have a smaller cross section than the other section 1682, and may move telescopically inside the other section 1682. The sections 1681 and 1682 may be connected together by a joint 1671 and a pin 1673. The pin 1673 may be removed to allow the sections 1681 and 1682 to move against each other to adjust the length of the L-shaped bar 1610.

The L-shaped bar 1620 may include two sections 1684 and 1685. One of the sections, for example, section 1684 may have a smaller cross section than the other section 1685, and may move telescopically inside the other section 1685. The sections 1684 and 1685 may be connected together by a joint 1672 and a pin 1674. The pin 1674 may be removed to allow the sections 1684 and 1685 to move against each other to adjust the length of the L-shaped bar 1620. Adjusting the lengths of the L-shaped bars 1610 and 1620 provides the technical advantage of allowing the wheel retainer 1631 to retain different size wheels.

With continued reference to FIGS. 16A-16B, the second hydraulic wheel lift assembly 1202 may include the wheel retainer 1641. The wheel retainer 1641, as shown in FIG. 16B, may include the cross bar 1665, the L-shaped bars 1640 and 1650, which may be connected to the cross bar 1665 by the pivots 1621 and 1622, respectively. The cross bar 1665 may be fixedly connected to the bar 1223 of the second hydraulic wheel lift 1202.

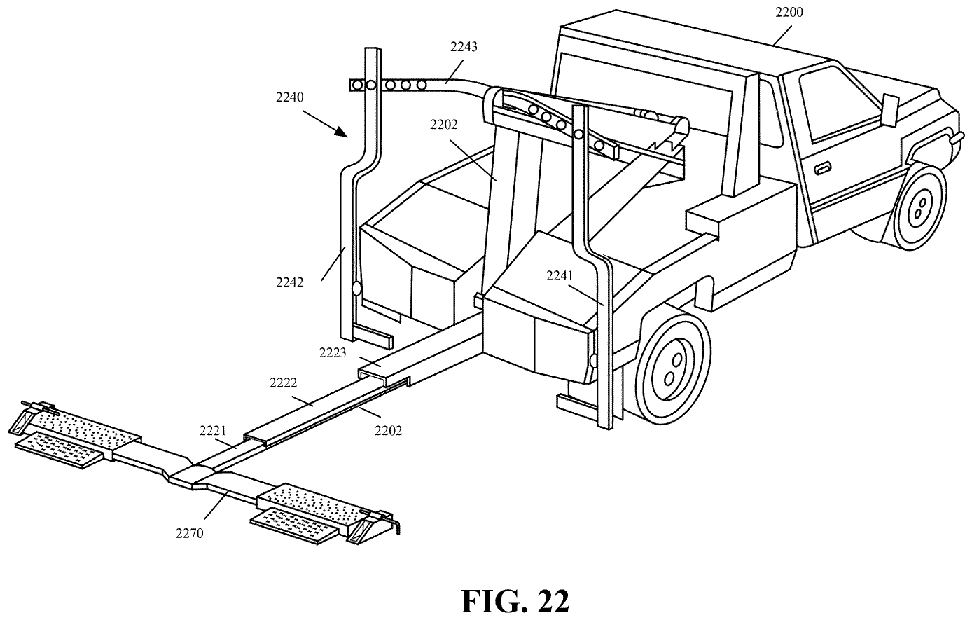

The wheel retainer 1641 may be configured to connect to towing wheels. In the example of FIG. 16B, the rods 193-194, the wheels 133, 1033, 134, 1034, and the spindles 143, 1043, 144, 1044 may be similar to the corresponding components of FIG. 10, described above. The wheel retainer structures 1631 and 1641 may also be used on other tow trucks of the present embodiments, such as, for example, the tow truck 100 of FIGS. 1A-1B, the tow truck 1800 of FIGS. 18A-18B, the tow truck 2100 of FIGS. 21A-21C, and the tow truck 2200 of FIG. 22.

The length of the L-shaped bars 1640 and 1650, in some embodiments, may be adjustable. As shown in FIG. 16B, the L-shaped bar 1640 may include two sections 1642 and 1643. One of the sections, for example, section 1642 may have a smaller cross section than the other section 1643, and may move telescopically inside the other section 1643. The sections 1642 and 1643 may be connected together by a joint 1691 and a pin 1693. The pin 1693 may be removed to allow the sections 1642 and 1643 to move against each other to adjust the length of the L-shaped bar 1640.

The L-shaped bar 1650 may include two sections 1644 and 1645. One of the sections, for example, section 1644 may have a smaller cross section than the other section 1645, and may move telescopically inside the other section 1645. The sections 1644 and 1645 may be connected together by a joint 1692 and a pin 1694. The pin 1694 may be removed to allow the sections 1644 and 1645 to move against each other to adjust the length of the L-shaped bar 1650. Adjusting the lengths of the L-shaped bars 1640 and 1650 provides the technical advantage of allowing the wheel retainer 1641 to retain different size wheels.

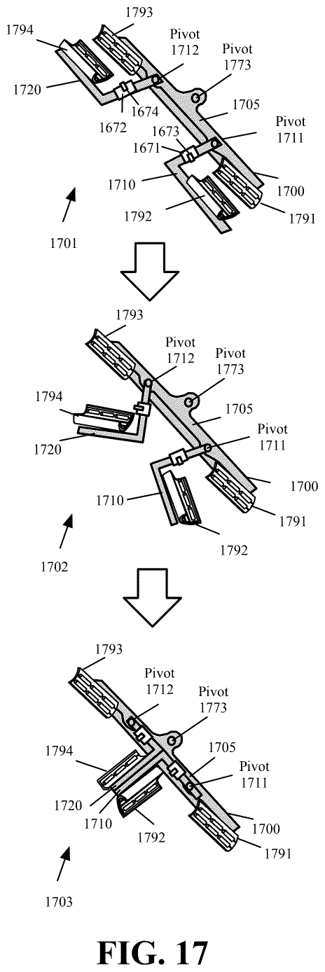

Some embodiments may use wheel retainers that include a cross bar, two L-shaped bars, and a set of rollers. FIG. 17 illustrates a top perspective view of a tow truck wheel retainer with a cross bar, two L-shaped bars, and four sets of rollers, according to prior art. With reference to FIG. 17, the wheel retainer 1700 may have a cross bar 1705, two L-shaped bars 1710 and 1720, and four sets of rollers 1791-1794. The two sections of each L-shaped bar 1710 and 1720 may intersect each other at a substantially 90 degrees angel. The two L-shaped bars 1710 and 1720 may be attached to the cross bar 1705 by the pivots 1711-1712, respectively. The two L-shaped bars 1710 and 1570, in some embodiments, may be attached to the cross bar 1705 by rotating plates or by a small hydraulic arms that may connect the L-shaped bars 1710 and 1720 to the cross bar 1705. The length of the L-shaped bar 1710 may be changed by the joint 1671 and the pin 1673, which may operate similar to the joint 1671 and the pin 1673 described above with reference to FIGS. 16A-16B. The length of the L-shaped bar 1720 may be changed by the joint 1672 and the pin 1674, which may operate similar to the joint 1672 and the pin 1674 described above with reference to FIGS. 16A-16B.

As shown in FIG. 17, two sets of rollers 1791 and 1793 are fixedly connected to the two ends of the cross bar 1705. Additionally, a set of rollers 1792 is connected to the L-shaped bar 1710, and a set of rollers 1794 is connected to the L-shaped bar 1720. The set of rollers 1791-1794 provide a similar function as the set rollers 171-174, described above.

FIG. 17, as shown, includes three operational stages 1701-1703. In stage 1701, the L-shaped bars 1710 and 1720 are extended, for example, to hold against the wheels of a car being towed. In stage 1702, the two L-shaped bars 1710 and 1720 are being rotated around the pivots 1711-1712, respectively. In stage 1703, the two L-shaped bars 1710 and 1720 are folded over the cross bar 1705, for example, after the completion of a towing task.

FIGS. 18A-18B are side perspective views of a tow truck 1800 with one hydraulic wheel lift assembly attached to a wheel retainer with a cross bar, two L-shaped bars, and four sets of rollers, and another hydraulic wheel lift assembly attached to a wheel retainer with a cross bar and two L-shaped bars, according to various aspects of the present disclosure.

The tow truck 1800 includes a first hydraulic wheel lift assembly 101 and a second hydraulic wheel lift assembly 1221, which may be similar to the hydraulic wheel lift assemblies 101 and 1221 of FIGS. 12A-12B.

With reference to FIGS. 18A-18B, the first hydraulic wheel lift assembly 101 may include the wheel retainer 1700, which may be similar to the wheel retainer 1700 of FIG. 17. The set of rollers 1791-1794 may be used to retain the two wheels of a vehicle that are closer to the tow truck 1800.

With continued reference to FIGS. 18A-18B, the second hydraulic wheel lift assembly 1202 may include the wheel retainer 1641. The wheel retainer 1641, which may be similar to the wheel retainer 1641 shown in FIG. 16B.

The wheel retainer 1641 may be configured to connect to towing wheels. In the example of FIG. 18B, the rods 193-194, the wheels 133, 1033, 134, 1034, and the spindles 143, 1043, 144, 1044 may be similar to the corresponding components of FIG. 10, described above. The wheel retainer structures 1631 and 1700 may also be used on other tow trucks of the present embodiments, such as, for example, the tow truck 100 of FIGS. 1A-1B, the tow truck 2100 of FIGS. 21A-21C, and the tow truck 2200 of FIG. 22.

The length of the L-shaped bars 1640 and 1650, in some embodiments, may be adjustable. As shown in FIG. 16B, the L-shaped bar 1640 may include two sections 1642 and 1643. One of the sections, for example, section 1642 may have a smaller cross section than, and may move telescopically inside, the other section 1643. The sections 1642 and 1643 may be connected together by a joint 1691 and a pin 1693. The pin 1693 may be removed to allow the sections 1642 and 1643 to move against each other to adjust the length of the L-shaped bar 1640.

The L-shaped bar 1650 may include two sections 1644 and 1645. One of the sections, for example, section 1644 may have a smaller cross section than, and may move telescopically inside, the other section 1645. The sections 1644 and 1645 may be connected together by a joint 1692 and a pin 1694. The pin 1694 may be removed to allow the sections 1644 and 1645 to move against each other to adjust the length of the L-shaped bar 1650. Adjusting the lengths of the L-shaped bars 1640 and 1650 provides the technical advantage of allowing the wheel retainer 1641 to retain different size wheels.

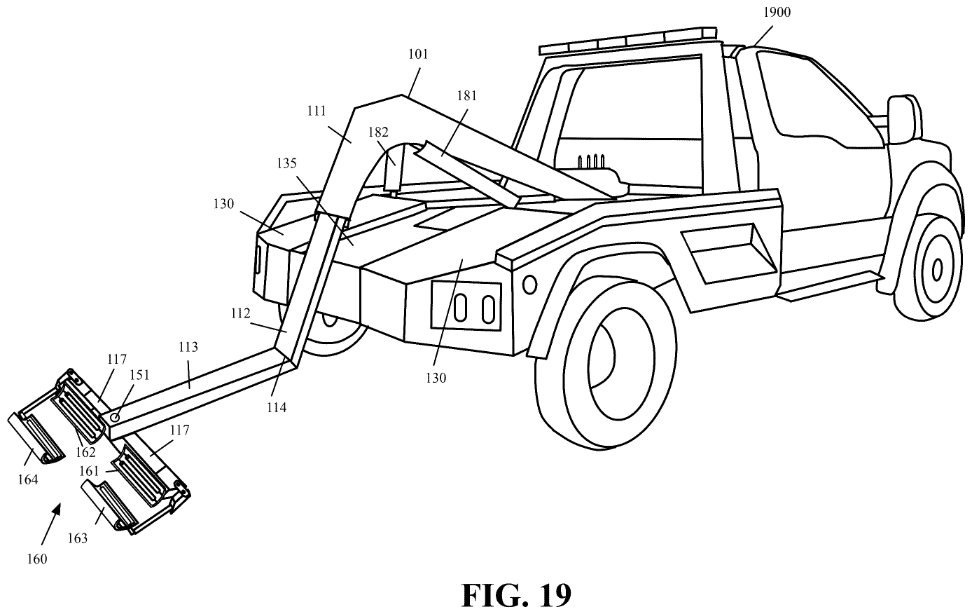

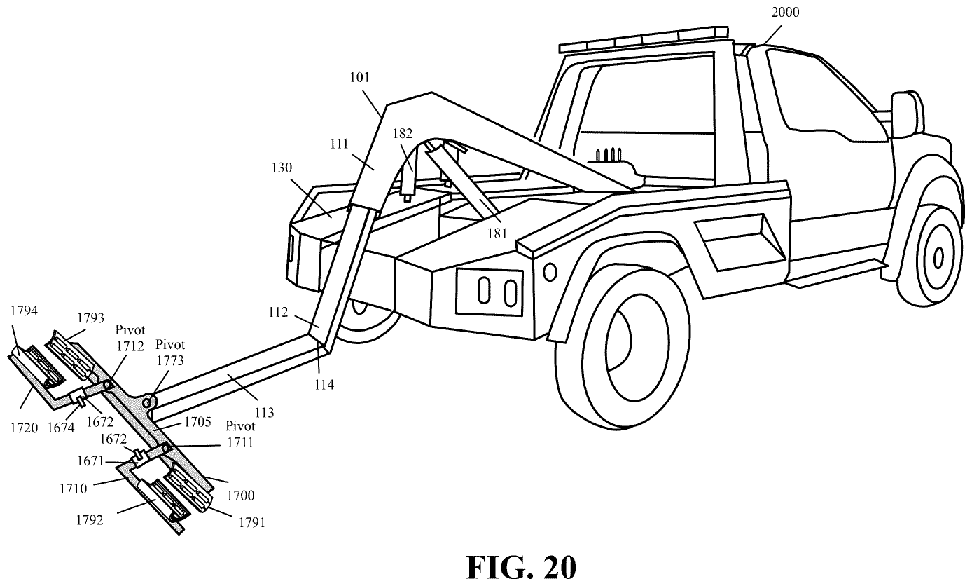

The wheel retainers of the present embodiments that include rollers may be used by the traditional tow trucks that only have one hydraulic wheel lift as well as the tow trucks of the present embodiments that include two hydraulic wheel lifts. FIG. 19 is a side perspective view of a tow truck with a hydraulic wheel lift assembly with four sets of roller for retaining the wheels of a vehicle that are closer to the tow truck, according to various aspects of the present disclosure. FIG. 20 is a side perspective view of a tow truck with a hydraulic wheel lift assembly attached to a wheel retainer with a cross bar, two L-shaped bars, and four sets of rollers for retaining the wheels of a vehicle that are closer to the tow truck, according to various aspects of the present disclosure.

With reference to FIGS. 19 and 20, each of the tow trucks 1900 and 2000 have only one hydraulic lift assembly 101. The tow truck 1900 includes the wheel retainers 161-164 that include rollers, and the tow truck 2000 includes the wheel retainers 1791-1794 that include rollers. Using the wheel retainers of the present embodiments that include rollers in the traditional tow trucks provides the technical advantage of allowing the two wheels that are lifted to rotate over the rollers at the same time that the two wheels that are on the ground rotate, without damaging the drivetrain of the vehicle.

In some embodiments, both of the first and second hydraulic wheel lift assemblies may extend, for at least a portion of their lengths, through a common axis. FIG. 21A is a side perspective view of a tow truck with two hydraulic wheel lift assemblies that may extend, for at least a portion of their lengths, through a common axis, according to various aspects of the present disclosure. FIG. 21B is a side perspective view of the tow truck of FIG. 21A after the first hydraulic wheel lift assembly is lifted up, according to various aspects of the present disclosure. FIG. 21C is a side perspective view of the tow truck of FIG. 21A after both hydraulic wheel lift assemblies are lifted up, according to various aspects of the present disclosure.

With reference to FIG. 21A, the tow truck 2100 may include a first hydraulic wheel lift assembly 2101 and the wheel retainers 2151 and 2152 for lifting the two wheels of a vehicle that are closer to the tow truck 2100. The tow truck 2100 may include a second hydraulic wheel lift assembly 2102 and the wheel retainers 2171 and 2172 for lifting the two wheels of the vehicle that are farther from the tow truck 2100.

The two hydraulic cylinders 2131-2132 may be configured to move the first hydraulic wheel lift 2101 up, down, forward, backward, and sideways. Other embodiments may include fewer or more than two hydraulic cylinders for moving the hydraulic wheel lift assembly 2101. The hydraulic wheel lift assembly 2101 may include several beams 2111-2113. The beams 2111-2113, in some embodiments, may have substantially rectangular cross sections. At least some of the beams, such as the beam 2112 may be hollow to facilitate a telescopic movement. In the example of FIG. 21A, the beams 2111 and 2112 are telescopic, with the beam 2111 having a smaller cross section than the beam 2112.

The beams 2112 and 2113 may move at an angle and tilt against each other around a hinge, or movable joint (not shown). In the example of FIG. 21A, the hydraulic wheel lift assembly 2101 is shown to include three beams 2111-2113, where the beam 2111 telescopically moves in and out of the beam 2112, and the beam 2112 may rotate around a hinge against the beam 2113. In other embodiments, the hydraulic wheel lift assembly 2101 may include fewer or more than three beams, may include more than two telescopic arms, may include more than two arms with hinges between them, may include no telescopic arms, or may include no hinges between the arms.

The hydraulic cylinder 2141 may be configured to move the hydraulic wheel lift assembly 2102 up, down, forward, or backward. Other embodiments may include no external hydraulic cylinders or more than one hydraulic cylinders for moving the hydraulic wheel lift 2102. The hydraulic wheel lift assembly 2102 may include several telescopic beams 2121-2123. In the perspective view of FIG. 21A, a portion of the beam 2122 of the second hydraulic wheel lift assembly 2102 is hidden under the arm 2112 of the first hydraulic wheel lift assembly 2101.

The beam 2121 may telescopically move in and out of the beam 2122 and the beam 2122 may rotate around a hinge (not shown) against the beam 2123. At least some of the beams, such as the beam 2122 may be hollow to facilitate the telescopic movements.

As shown, the hydraulic wheel lift assembly 2101 may be connected to a wheel retainer structure 2160 and the hydraulic wheel lift 2102 may be connected to a wheel retainer structure 2170. The wheel retainer structures 2160 and 2170 may be similar to any of the wheel retainer structures 160 and 190 (FIGS. 1A-1B), 1401-1402 (FIGS. 14), 1500 (FIGS. 15), 1631 and 1641 (FIGS. 16A-16B), and/or 1631 and 1700 (FIGS. 18A-18B). The wheel retainer structure 2160 may rotate against the beam 2122 around the pivot 2190. The wheel retainer structure 2170 may be used to attach to towing wheels (not shown), for example as described above with reference to FIGS. 1B, 7, 10, 11, 12B, 14, and/or 16B.

With reference to FIG. 21B, the first hydraulic wheel lift assembly 2101 is shown as lifted while the second hydraulic wheel lift assembly 2102 is extended above the ground. FIG. 21C shows the tow truck 2100 after both hydraulic wheel lift assemblies 2101 and 2102 are lifted up (e.g., when the tow truck 2100 is not towing a vehicle).

In some embodiments, the tow truck may include a boom to lift the wheels of a vehicle that are closer to the tow truck and a hydraulic wheel lift assembly for placing towing wheels under the wheels of the vehicle that are father from the tow truck. FIG. 22 is a side perspective view of a tow truck with a boom to lift the wheels of a vehicle that are closer to the tow truck and a hydraulic wheel lift assembly for placing towing wheels under the wheels of the vehicle that are father from the tow truck, according to various aspects of the present disclosure.

With reference to FIG. 22, the tow truck 2200 may include the boom 2240 for lifting the two wheels of a vehicle that are closer to the truck 2200 and a hydraulic wheel lift assembly 2202 for lifting the two wheels of the vehicle that are farther from the tow truck 2200. The boom 2240 may include a cross bar 2243 and two bars 2241 and 2242. The two bars 2241 and 2242 may be used to lift the two wheels of the vehicle being towed that are closer to the tow truck 2200.

The hydraulic wheel lift assembly 2202 may include several telescopic beams 2221-2223. The beam 2221 may telescopically move in and out of the beam 2222 and the beam 2222 may telescopically move in and out of the beam 2223. At least some of the beams, such as the beams 2222 and 2223 may be hollow to facilitate the telescopic movements.

As shown, the hydraulic wheel lift assembly 2202 may be connected to a wheel retainer structure 2270. The wheel retainer structure 2270 may be similar to any of the wheel retainer structures 170 (FIGS. 1A-1B), 1470 (FIGS. 14), 1500 (FIGS. 15), 1641 (FIGS. 16A-16B), and/or 1700 (FIGS. 18A-18B). The wheel retainer structure 2270 may be used to attach to towing wheels, for example as described above with reference to FIGS. 1B, 7, 10, 11, 12B, 14, and/or 16B.

In a first aspect, a wheel lift apparatus of a tow truck is provided. The wheel lift apparatus includes: a first hydraulic wheel lift assembly comprising: a first set of one or more hydraulically operated arms configured to attach to a body of the tow truck at a first location; and a first wheel retainer structure connected to the first set of hydraulically operated arms, the first wheel retainer structure configured to hold a first pair of wheels of a vehicle off the ground during a towing operation; and a second hydraulic wheel lift assembly configured to extend and retract below the first hydraulic wheel lift assembly, the second hydraulic wheel lift assembly comprising: a second set of one or more hydraulically operated arms configured to attach to the body of the tow truck at a second location; and a second wheel retainer structure connected to the second set of hydraulically operated arms, the second wheel retainer structure configured to hold a second pair of wheels of the vehicle, which are located farther to the tow truck than the first pair of wheels, the wheel retainer structure comprising: a first shaft configured to connect to a first towing wheel that keeps a first wheel in the second pair of the wheels of the vehicle off the ground; a first wheel retainer configured to hold the first wheel in the second pair of the wheels of the vehicle; a second shaft configured to connect to a second towing wheel that keeps a second wheel in the second pair of the wheels of the vehicle off the ground; and a second wheel retainer configured to hold the second wheel in the second pair of the wheels of the vehicle.

In an embodiment of the first aspect, the second wheel retainer structure includes: a cross bar connected to a hydraulically operated arm in the second set of hydraulically operated arms, wherein the first and second wheel retainers are fixedly connected to the cross bar, wherein the cross bar comprises first and second ends; a first rod movably connected to the first end of cross bar, and fixedly connected to the first shaft; and a second rod movably connected to second first end of cross bar, and fixedly connected to the second shaft.

An embodiment of the first aspect further comprises: a first bracket fixedly connected to the first end of the cross bar, wherein the first bracket is configured to hold the first rod; and a second bracket fixedly connected to second first end of the cross bar, wherein the second bracket is configured to hold the second rod.

Another embodiment of the first aspect further comprises: a third wheel retainer detachably connected to the first end of the cross bar through the first bracket, wherein the third wheel retainer is configured to hold the first wheel in the second pair of the wheels of the vehicle, wherein the first and third wheel retainers hold two substantially opposite sides of the first wheel; and a fourth wheel retainer detachably connected to the second end of the cross bar through the second bracket, wherein the fourth wheel retainer is configured to hold the second wheel in the second pair of the wheels of the vehicle, wherein the second and fourth wheel retainers hold two substantially opposite sides of the second wheel.

Another embodiment of the first aspect further comprises: at least one hydraulic cylinder that moves the first set of one or more hydraulically operated arms; and at least one hydraulic cylinder that moves the second set of one or more hydraulically operated arms.

In another embodiment of the first aspect, the first wheel retainer comprises a first set of one or more rollers; the second wheel retainer comprises a second set of one or more rollers; and the first and second set of rollers are configured to allow the second pair of wheels of the vehicle to role.

In another embodiment of the first aspect, the first wheel retainer comprises a plurality of pairs of holes, each pair of holes configured to removably connect a roller in the first set of rollers to the first wheel retainer.

In another embodiment of the first aspect, the second wheel retainer comprises a plurality of pairs of holes, each pair of holes configured to removably connect a roller in the second set of rollers to the second wheel retainer.

In another embodiment of the first aspect, the first and second sets of rollers are made of a material comprising one of metal, rubber, carbon fiber, and graphite.

In another embodiment of the first aspect, the first wheel retainer structure comprises: a third wheel retainer comprising a first set of one or more rollers, the third wheel retainer configured to hold a first wheel in the first pair of the vehicle; a fourth wheel retainer comprising a second set of one or more rollers, the fourth wheel retainer configured to hold a second wheel in the first pair of the vehicle; wherein the first and second set of one or more rollers are configured to allow the first pair of wheels to role when the second pair of wheels are placed on the ground and move.

In another embodiment of the first aspect, the third wheel retainer comprises a plurality of pairs of holes, each pair of holes configured to removably connect a roller in the first set of rollers to the third wheel retainer.

In another embodiment of the first aspect, the fourth wheel retainer comprises a plurality of pairs of holes, each pair of holes configured to removably connect a roller in the second set of rollers to the fourth wheel retainer.

In another embodiment of the first aspect, the first wheel retainer structure comprises: a cross bar connected to a hydraulically operated arm in the first set of hydraulically operated arms, wherein the third and fourth wheel retainers are fixedly connected to the cross bar, wherein the cross bar comprises first and second ends; a first rod movably connected to the first end of cross bar, and fixedly connected to the first shaft; and a second rod movably connected to second first end of cross bar, and fixedly connected to the second shaft.

Another embodiment of the first aspect further comprises: a first bracket fixedly connected to the first end of the cross bar, wherein the first bracket is configured to hold the first rod; and a second bracket fixedly connected to second first end of the cross bar, wherein the second bracket is configured to hold the second rod.

Another embodiment of the first aspect further comprises a fifth wheel retainer detachably connected to the first end of the cross bar through the first bracket, wherein the fifth wheel retainer is configured to hold the first wheel in the first pair of the wheels of the vehicle, wherein the third and fifth wheel retainers hold two substantially opposite sides of the first wheel of the first pair of the wheels of the vehicle; and a sixth wheel retainer detachably connected to the second end of the cross bar through the second bracket, wherein the sixth wheel retainer is configured to hold the second wheel in the first pair of the wheels of the vehicle, wherein the fourth and sixth wheel retainers hold two substantially opposite sides of the second wheel in the first pair of the wheels of the vehicle.

Another embodiment of the first aspect further comprises a first pivot, wherein the cross bar and said hydraulically operated arm in the first set of hydraulically operated arms are connected by the first pivot.

Another embodiment of the first aspect further comprises a second pivot connecting two hydraulically operated arms in the second set of hydraulically operated arms, wherein the first and second pivots substantially position in a same vertical plane when the first and second hydraulic wheel lift assemblies are fully extended.

In a second aspect, a wheel lift apparatus of a tow truck is provided. The wheel lift apparatus includes a hydraulic wheel lift assembly that includes: a first set of one or more hydraulically operated arms configured to attach to a body of the tow truck; and a first wheel retainer structure connected to the first set of hydraulically operated arms, the first wheel retainer structure configured to hold a first pair of wheels of a vehicle off the ground during a towing operation. The first wheel retainer structure includes: a cross bar connected to at least one of the hydraulically operated arms in the first set of hydraulically operated arms; a first wheel retainer connected to the cross bar, the first wheel retainer comprising a first frame, and a first plurality of rollers connected to the first frame; a second wheel retainer removably connected by a first rod to the cross bar, the second wheel retainer comprising a second frame, and a second plurality of rollers connected to the second frame; a third wheel retainer connected to the cross bar, the third wheel retainer comprising a third frame, and a third plurality of rollers connected to the third frame; a fourth wheel retainer removably connected by a second rod to the cross bar, the fourth wheel retainer comprising a fourth frame, and a fourth plurality of rollers connected to the second frame. The first and second wheel retainers are configured to hold a first wheel of a vehicle off the ground during a towing operation. The third and fourth wheel retainers are configured to hold a second wheel of the vehicle off the ground during the towing operation. The first plurality of rollers are configured to engage a first side of the first wheel of the vehicle. The second plurality of rollers are configured to engage a second side of the first wheel of the vehicle. The first and second plurality of rollers are configured to allow the first wheel of the vehicle to rotate during the towing operation. The third plurality of rollers are configured to engage a first side of the second wheel of the vehicle. The fourth plurality of rollers are configured to engage a second side of the second wheel of the vehicle, wherein the third and fourth plurality of rollers are configured to allow the second wheel of the vehicle to rotate during the towing operation.

In an embodiment of the second aspect, the length of the first rod is adjustable to change a distance between the first and second wheel retainers, and the length of the second rod is adjustable to change a distance between the third and fourth wheel retainers.

In another embodiment of the second aspect, each of the first, second, third, and fourth frame comprises a plurality of pairs of holes, each pair of holes configured to removably connect a roller to the corresponding frame.

In another embodiment of the second aspect, the first and third wheel retainers are fixedly connected to the cross bar.

In another embodiment of the second aspect, the cross bar includes first and second ends. The wheel lift apparatus further includes: a first bracket fixedly connected to the first end of the cross bar, wherein the first bracket is configured to hold the first rod; and a second bracket fixedly connected to second first end of the cross bar, wherein the second bracket is configured to hold the second rod.

In another embodiment of the second aspect, the cross bar includes first and second ends. The wheel lift apparatus further includes: a first rotatable rod connected to the first end of the cross bar, the first rotatable rod configured to prevent the first wheel of the vehicle being towed to disengage from the first and second wheel retainers; and a second rotatable rod connected to the second end of the cross bar, the second rotatable rod configured to prevent the second wheel of the vehicle being towed to disengage from the third and fourth wheel retainers.

In another embodiment of the second aspect, the first side of the first wheel of the vehicle engaged by the first plurality of rollers and the second side of the first wheel of the vehicle engaged by the second plurality of rollers are substantially opposite to each other. The first side of the second wheel of the vehicle engaged by the third plurality of rollers and the second side of the second wheel of the vehicle engaged by the fourth plurality of rollers are substantially opposite to each other.

In another embodiment of the second aspect, the first, second, third, and fourth plurality of rollers are made of a material comprising one of metal, rubber, carbon fiber, and graphite.

An embodiment of the second aspect further includes at least one hydraulic cylinder that moves the first set of one or more hydraulically operated arms.

In another embodiment of the second aspect, the wheel retainer structure is a first wheel retainer structure, the wheel lift apparatus further includes: a second hydraulic wheel lift assembly configured to extend and retract below the first hydraulic wheel lift assembly, the second hydraulic wheel lift assembly includes: a second set of one or more hydraulically operated arms configured to attach to the body of the tow truck; and a second wheel retainer structure connected to the second set of hydraulically operated arms, the second wheel retainer structure configured to hold third and fourth wheels of the vehicle during the towing operation, the third and fourth wheels of the vehicle are located farther to the tow truck than the first and second wheels of the vehicle, the second wheel retainer structure includes: a first shaft configured to connect to a first towing wheel that keeps the third wheel of the vehicle off the ground; fifth and sixth wheel retainers configured to hold the third wheel of the vehicle; a second shaft configured to connect to a second towing wheel that keeps a fourth wheel of the vehicle off the ground; and seventh and eight wheel retainers configured to hold the fourth wheel of the vehicle.

In another embodiment of the second aspect, the second hydraulic wheel lift assembly is configured to extend and retract below the first hydraulic wheel lift assembly.

In another embodiment of the second aspect, the second hydraulic wheel lift assembly is configured to move substantially parallel to the first hydraulic wheel lift assembly.

In another embodiment of the second aspect, the cross bar is a first cross bar, wherein the second wheel retainer structure includes: a second cross bar connected to a hydraulically operated arm in the second set of hydraulically operated arms, wherein the fifth and seventh wheel retainers are fixedly connected to the second cross bar.

In another embodiment of the second aspect, the sixth wheel retainer is removably connected by a first rod to the second cross bar, and the eight wheel retainer is removably connected by a second rod to the second cross bar.

In another embodiment of the second aspect, the length of the first rod is adjustable to change a distance between the fifth and sixth wheel retainers, and the length of the second rod is adjustable to change a distance between the seventh and eight wheel retainers.

In another embodiment of the second aspect, the second cross bar includes first and second ends. The second wheel retainer structure includes: a first bracket fixedly connected to the first end of the second cross bar, wherein the first bracket is configured to hold the first rod; and a second bracket fixedly connected to the second first end of the second cross bar, wherein the second bracket is configured to hold the second rod.

Another embodiment of the second aspect further includes at least one hydraulic cylinder that moves the second set of one or more hydraulically operated arms.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

1. A wheel lift apparatus of for a tow truck, the wheel lift apparatus comprising:
a hydraulic wheel lift assembly comprising:
a first set of one or more hydraulically operated arms configured to attach to a body of the tow truck; and
a first wheel retainer structure connected to the first set of hydraulically operated arms, the first wheel retainer structure configured to hold a first pair of wheels of a vehicle off the ground during a towing operation, the first wheel retainer structure comprising:
a cross bar connected to at least one of the hydraulically operated arms in the first set of hydraulically operated arms;
a first wheel retainer connected to the cross bar, the first wheel retainer comprising a first frame, and a first plurality of rollers connected to the first frame;
a second wheel retainer removably connected by a first rod to the cross bar, the second wheel retainer comprising a second frame, and a second plurality of rollers connected to the second frame;
a third wheel retainer connected to the cross bar, the third wheel retainer comprising a third frame, and a third plurality of rollers connected to the third frame;
a fourth wheel retainer removably connected by a second rod to the cross bar, the fourth wheel retainer comprising a fourth frame, and a fourth plurality of rollers connected to the second fourth frame;
wherein the first and second wheel retainers are configured to hold a first wheel of a vehicle off the ground during a towing operation, wherein the third and fourth wheel retainers are configured to hold a second wheel of the vehicle off the ground during the towing operation,
wherein the first plurality of rollers are configured to engage a first side of the first wheel of the vehicle, wherein the second plurality of rollers are configured to engage a second side of the first wheel of the vehicle, wherein the first and second plurality of rollers are configured to allow the first wheel of the vehicle to rotate during the towing operation, and
wherein the third plurality of rollers are configured to engage a first side of the second wheel of the vehicle, wherein the fourth plurality of rollers are configured to engage a second side of the second wheel of the vehicle, wherein the third and fourth plurality of rollers are configured to allow the second wheel of the vehicle to rotate during the towing operation.

2. The wheel lift apparatus of claim 1, wherein a length of the first rod is adjustable to change a distance between the first and second wheel retainers, and wherein a length of the second rod is adjustable to change a distance between the third and fourth wheel retainers.

3. The wheel lift apparatus of claim 1, wherein each of the first, second, third, and fourth frame frames comprises a plurality of pairs of holes, and wherein each pair of holes in the plurality of pairs of holes is configured to removably connect a roller to the corresponding frame.

4. The wheel lift apparatus of claim 1, wherein the first and third wheel retainers are fixedly connected to the cross bar.

5. The wheel lift apparatus of claim 1, wherein the cross bar comprises first and second ends, the wheel lift apparatus further comprising:
a first bracket fixedly connected to the first end of the cross bar, wherein the first bracket is configured to hold the first rod; and
a second bracket fixedly connected to the second first end of the cross bar, wherein the second bracket is configured to hold the second rod.

6. The wheel lift apparatus of claim 1, wherein the cross bar comprises first and second ends, the wheel lift apparatus further comprising:
a first rotatable rod connected to the first end of the cross bar, the first rotatable rod configured to prevent the first wheel of the vehicle being towed from disengaging from the first and second wheel retainers; and
a second rotatable rod connected to the second end of the cross bar, the second rotatable rod configured to prevent the second wheel of the vehicle being towed from disengaging from the third and fourth wheel retainers.

7. The wheel lift apparatus of claim 1, wherein the first side of the first wheel of the vehicle engaged by the first plurality of rollers and the second side of the first wheel of the vehicle engaged by the second plurality of rollers are substantially opposite to each other, wherein the first side of the second wheel of the vehicle engaged by the third plurality of rollers and the second side of the second wheel of the vehicle engaged by the fourth plurality of rollers are substantially opposite to each other.

8. The wheel lift apparatus of claim 1, wherein the first, second, third, and fourth plurality of rollers are made of a material comprising one or more of metal, rubber, carbon fiber, and graphite.

9. The wheel lift apparatus of claim 1 further comprising:
at least one hydraulic cylinder that moves the first set of one or more hydraulically operated arms.

10. The wheel lift apparatus of claim 1, wherein the wheel retainer structure is a first wheel retainer structure, the wheel lift apparatus further comprising:
a second hydraulic wheel lift assembly configured to extend and retract below the first hydraulic wheel lift assembly, the second hydraulic wheel lift assembly comprising:
a second set of one or more hydraulically operated arms configured to attach to the body of the tow truck; and
a second wheel retainer structure connected to the second set of hydraulically operated arms, the second wheel retainer structure configured to hold third and fourth wheels of the vehicle during the towing operation, wherein the third and fourth wheels of the vehicle are located farther to from the tow truck than the first and second wheels of the vehicle, the second wheel retainer structure comprising:
a first shaft configured to connect to a first towing wheel that keeps the third wheel of the vehicle off the ground;
fifth and sixth wheel retainers configured to hold the third wheel of the vehicle;
a second shaft configured to connect to a second towing wheel that keeps the fourth wheel of the vehicle off the ground; and
seventh and eighth wheel retainers configured to hold the fourth wheel of the vehicle.

11. The wheel lift apparatus of claim 10, wherein the second hydraulic wheel lift assembly is configured to extend and retract below the first hydraulic wheel lift assembly.

12. The wheel lift apparatus of claim 10, wherein the second hydraulic wheel lift assembly is configured to move substantially parallel to the first hydraulic wheel lift assembly.

13. The wheel lift apparatus of claim 10, wherein the cross bar is a first cross bar, wherein the second wheel retainer structure comprises:
a second cross bar connected to a hydraulically operated arm in the second set of hydraulically operated arms, wherein the fifth and seventh wheel retainers are fixedly connected to the second cross bar.

14. The wheel lift apparatus of claim 10, wherein the sixth wheel retainer is removably connected by a first rod to the second cross bar, wherein the eight eighth wheel retainer is removably connected by a second rod to the second cross bar.

15. The wheel lift apparatus of claim 14, wherein a length of the first rod is adjustable to change a distance between the fifth and sixth wheel retainers, wherein a length of the second rod is adjustable to change a distance between the seventh and eight eighth wheel retainers.

16. The wheel lift apparatus of claim 14, wherein the second cross bar comprises first and second ends, wherein the second wheel retainer structure comprises:
a first bracket fixedly connected to the first end of the second cross bar, wherein the first bracket is configured to hold the first rod; and
a second bracket fixedly connected to the second first end of the second cross bar, wherein the second bracket is configured to hold the second rod.

17. The wheel lift apparatus of claim 10 further comprising:
at least one hydraulic cylinder that moves the second set of one or more hydraulically operated arms.
